(19) United States
(12) Patent Application Publication
(10) Pub. No.: US 2006/0110131 A1
(43) Pub. Date: May 25, 2006

(54) Data processing device

(76) Inventors: Osamu Okauchi, Hirakata-shi (JP); Tadashi Nakamura, Nara-shi, Nara (JP); Hideshi Ishihara, Katano-shi (JP); Yasuyuki Kurosawa, Katano-shi (JP); Masanori Ito, Moriguchi-shi (JP)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 10/528,165

(22) PCT Filed: Oct. 15, 2003
(86) PCT No.: PCT/JP03/13215

§ 371 Date: Aug. 29, 2005

(30) Foreign Application Priority Data
Oct. 17, 2002 (JP) 2002-302925
Apr. 23, 2003 (JP) 2003-118253

(51) Int. Cl. H04N 7/52

(52) U.S. Cl. 386/95; 386/131

(57) ABSTRACT

A data processor (10) according to the present invention includes: a video signal receiving section (100) for receiving a video signal representing video and aspect information to control aspect ratio of the video; an audio signal receiving section (102) for receiving an audio signal representing audio; a detecting section (104) for detecting the aspect information from the video signal; a stream generating section (101) for generating encoded data by encoding the video and audio signals by a predetermined encoding technique and also generating an encoded stream as a set of the encoded data; management information generating section (106) for generating management information to manage the encoded stream being processed, the management information including the aspect information for each set of the encoded data; and a writing section (120) for storing the management information and the encoded stream as at least one file on a storage medium.

### TECHNICAL FIELD

The present invention relates to a data processor and processing method for storing moving picture stream data on a storage medium such as an optical disc.

### BACKGROUND ART

Recently, in an analog telecast, data is sometimes multiplexed in a vertical blanking interval (which will be abbreviated herein as “VBI”) of a broadcast signal. For example, in a closed-captioned broadcast, closed-caption data is multiplexed in a VBI. In a TV signal (or video signal) compliant with the National Television System Committee (NTSC) standard, one frame (i.e., two fields) consists of 525 horizontal scan lines. Among those horizontal scan lines corresponding to VBIs, data can be multiplexed in an interval corresponding to the 10^{th} through 21^{st} lines and in an interval corresponding to the 273^{rd} through 284^{th} lines. It should be noted that the technique of multiplexing VBI data with a TV signal is as defined by Proceedings of the National Television Academy Vol. 49, No. 9 (1995) and an European broadcasting standard ETS300 294, “Television Systems 625-Line Television Wide Screen Signaling (WSS)”. The data to be multiplexed in a VBI will be referred to herein as “VBI data”.

The VBI data includes not only closed caption data but also aspect information and copy control information as well. The aspect information represents the aspect ratio (i.e., the ratio of the lateral width to the vertical height) of a picture being presented on a display and may be 4 to 3 or 16 to 9, for example. Meanwhile, the “copy control information” indicates whether or not a videocassette recorder (VCR) may record given video. A VCR that can record video by the S-VHS (Super-Video Home System) standard can write a TV signal, on which VBI data is superposed, on a videotape. When a TV signal that has been written in that manner is read, the VBI data can be extracted.

A TV signal used to be recorded with a VCR in the past but is recently recorded digitally more and more often with a PC, for example. As used herein, “digital recording” means converting a TV signal into digital data with a PC, for example, and writing it as moving picture stream data on a storage medium such as an optical disc or a hard disk.

The MP4 file format as defined by the MPEG-4 system standard (ISO/IEC 14496-1) is widely known as a file format that can deal with such stream data and that is highly compatible with a PC. The MP4 file format is defined based on the QuickTime™ file format of Apple Corporation, and is a promising format because it is currently supported by various PC applications. The QuickTime file format, which forms the basis of the MP4 file format, is now used extensively as a file format for handling moving pictures and audio in the fields of PC applications.

FIG. 1 shows a format for an MP4 file 1. The MP4 file 1 includes management information 2 and moving picture stream data 3. The moving picture stream data 3 is encoded video and audio data compliant with the MPEG-2 Video or MPEG-4 Video. Alternatively, the moving picture stream data 3 may also be data compliant with Motion JPEG, for example. The management information 2 is information about the data sizes, addresses of the data storage locations and frame-by-frame playback durations of the video and audio frames as defined for the moving picture stream data 3. A data playback apparatus can find the storage location of the moving picture stream 3 by reference to the management information 2 and can read and play back the moving picture stream 3.

FIG. 2 shows another format for an MP4 file. The management information 2 of the MP4 file and a moving picture stream 3 are provided as different files. In such an MP4 file, the management information 2 includes link information L for controlling reading of the moving picture stream 3. According to the QuickTime file format standard, the same file formats as those of the MP4 standard shown in FIGS. 1 and 2 may also be adopted. Thus, the following description about the MP4 file is equally applicable to a QuickTime file, too, unless otherwise stated, and is not limited to the MP4 file.

Hereinafter, a more specific format for the MP4 file 1 will be described with the MP4 file 1 shown in FIG. 1 taken as an example. FIG. 3 shows a specific format for the MP4 file 1. First, the moving picture stream portion thereof will be described. In the MP4 file 1, data in the moving picture stream is managed on a sample basis and on a chunk basis. As used herein, the “sample” is the smallest management unit of a stream in an MP4 file and may correspond to encoded frame data of a video frame or that of an audio frame. In FIG. 3, video samples 4 representing frame data of video frames and audio samples 5 representing frame data of audio frames are shown. On the other hand, the “chunk” refers to a set of one or more samples. Even if there is only one sample in a chunk, it is also managed as a chunk including just one sample.

In the management information, information about the video samples and information about the audio samples are managed on a track basis. An audio track 6 and a video track 7 are shown in FIG. 3. On each of these tracks 6 and 7, the sizes and playback durations of the respective samples and the top location of each chunk and the number of samples included in the chunk are described. The data playback apparatus can access every sample by reading each track of the management information and can control the read operation on a sample-by-sample basis or on a chunk-by-chunk basis. It should be noted that the information about the storage location of each sample or each chunk in the management information of the MP4 file is also called “access data”.

In writing a moving picture signal such as a TV signal in the MP4 file format, not only time series stream data such as video but also aspect information, copy control information and other types of information accompanying the moving picture signal need to be stored in the MP4 file. And in reading and outputting the stream data, those various types of information stored need to be added to the stream data with high fidelity.

However, the conventional MP4 file format has no areas to store the aspect information, copy control information and other types of information, which is a problem.

A format compliant with the DVD Video Recording standard (see “DVD Standard Part III for Rewritable/rerecordable Disks: Video Recording Standard Version 1.1” issued by DVD Forum) is known as a format that can handle a moving picture stream. In a format compliant with this standard, control information, indicating whether or not the moving picture stream may be copied, is inserted into the stream at regular time intervals, thereby performing a copy control on the moving picture stream (see Japanese Patent Application Laid-Open Publication No. 2001-86463).

As described above, some conventional formats require that the aspect information, copy control information or any other type of information be stored in the stream. However, according to such a data structure, the player has to handle a heavy processing load while reading a stream. This is because while carrying out the playback processing, the player needs to analyze the moving picture stream, detect and extract the aspect information, copy control information and other types of information, and perform the aspect processing and so on. Furthermore, a very limited amount of time is allowed the player to perform the aspect processing and so on, and there are quite modest resources that can be allocated to non-playback processing during the playback. As a result, the processing resources run too short in some cases to present the aspect information on the screen.

In addition, the only type of stream adopted in the conventional formats is an MPEG-2 stream, which is much less universal than the MP4 file format.

### DISCLOSURE OF INVENTION

An object of the present invention is to provide a data structure that can manage the aspect information, copy control information and other types of information as well as the time series data such as moving pictures while maintaining the universality of the QuickTime file or MP4 file and compliance with the MPEG-4 system standard (ISO/IEC 14496-1). Another object of the present invention is to provide a recorder that can store data based on such a data structure. Still another object of the present invention is to provide a player that can retrieve data with such a data structure.

A data storage apparatus according to the present invention includes: a video signal receiving section for receiving a video signal representing video and aspect information to control aspect ratio of the video; an audio signal receiving section for receiving an audio signal representing audio; a detecting section for detecting the aspect information from the video signal; a stream generating section for generating encoded data by encoding the video and audio signals by a predetermined encoding technique and also generating an encoded stream as a set of the encoded data; management information generating section for generating management information which is used to manage process of the encoded stream, the management information including the aspect information for each set of the encoded data; and a writing section for storing the management information and the encoded stream as at least one file on a storage medium.

When the set of the encoded data is treated as one sample, the management information generating section may generate common aspect information for the video in each sample.

When a plurality of samples are treated as one chunk, the management information generating section may generate common aspect information for the video in each chunk.

The management information generating section may generate and store the aspect information in a field of the management information for describing an attribute of each said sample.

If the at least one file is compliant with the QuickTime standard, then the field may be a Sample Table Atom (stbl) field. On the other hand, if the at least one file is compliant with the MP4 standard, then the field may be a Sample Table Box (stbl) field.

The management information generating section may generate and store the aspect information in a field of the management information for describing user data with respect to the encoded stream.

If the at least one file is compliant with the QuickTime standard, then the field may be a User Data Atom field. On the other hand, if the at least one file is compliant with the MP4 standard, then the field may be a User Data Box field.

The management information generating section may further store access information, which is needed in accessing each said sample to which the aspect information is applied, in the field. The access information may include at least one of the number of samples included in the chunk and the playback duration, data storage location and data size of each said sample.

The video signal may include copy information indicating whether the video signal may or may not be copied. The detecting section may detect the copy information from the video signal. And the management information generating section may further generate copy control information as another piece of the management information. The copy control information may include copy protection information, showing a method of protecting the encoded stream from being copied in accordance with the copy information, and status information indicating whether the copy protection information is valid or not.

If the copy information indicates that copy of the video signal may be allowed at least once, then the management information generating section may generate the copy control information.

The management information generating section may generate common copy control information for the video in each said sample.

Alternatively, the management information generating section may generate common copy control information for the video in each said chunk.

If the at least one file is compliant with the QuickTime standard, then the management information generating section may describe the copy control information in one of a Sample Table Atom (stbl) field and a User Data Atom (udta) field. On the other hand, if the at least one file is compliant with the MP4 standard, then the management information generating section may describe the copy control information in one of a Sample Table Box (stbl) field and a User Data Box field.

A data storage method according to the present invention includes the steps of: receiving a video signal representing video and aspect information to control aspect ratio of the video; receiving an audio signal representing audio; detecting the aspect information from the video signal; generating encoded data by encoding the video and audio signals by a predetermined encoding technique and also generating an encoded stream as a set of the encoded data; generating management information which is used to manage process of the encoded stream, the management information including the aspect information for each set of the encoded data; and storing the management information and the encoded stream as at least one file on a storage medium.

When the set of the encoded data is treated as one sample, the step of generating the management information may include generating common aspect information for the video in each sample.

When a plurality of samples are treated as one chunk, the step of generating the management information may include generating common aspect information for the video in each chunk.

The step of generating the management information may include generating and storing the aspect information in a field of the management information for describing an attribute of each said sample.

If the at least one file is compliant with the QuickTime standard, then the field may be a Sample Table Atom (stbl) field. On the other hand, if the at least one file is compliant with the MP4 standard, then the field may be a Sample Table Box (stbl) field.

The step of generating the management information may include generating and storing the aspect information in a field of the management information for describing user data with respect to the encoded stream.

If the at least one file is compliant with the QuickTime standard, then the field may be a User Data Atom field. On the other hand, if the at least one file is compliant with the MP4 standard, then the field may be a User Data Box field.

The step of generating the management information may further include storing access information, which is needed in accessing each said sample to which the aspect information is applied, in the field. The access information may include at least one of the number of samples included in the chunk and the playback duration, data storage location and data size of each said sample.

The video signal may include copy information indicating whether the video signal may or may not be copied. The step of detecting may include detecting the copy information from the video signal. And the step of generating the management information may further include generating copy control information as another piece of the management information. The copy control information may include copy protection information, showing a method of protecting the encoded stream from being copied in accordance with the copy information, and status information indicating whether the copy protection information is valid or not.

If the copy information indicates that copy of the video signal may be allowed at least once, then the step of generating the management information may include generating the copy control information.

The step of generating the management information may include generating common copy control information for the video in each said sample.

Alternatively, the step of generating the management information may include generating common copy control information for the video in each said chunk.

If the at least one file is compliant with the QuickTime standard, then the step of generating the management information may include describing the copy control information in one of a Sample Table Atom (stbl) field and a User Data Atom (udta) field. On the other hand, if the at least one file is compliant with the MP4 standard, then the step of generating the management information may include describing the copy control information in one of a Sample Table Box (stbl) field and a User Data Box field.

A data playback apparatus according to the present invention includes: a reading section for reading an encoded stream as a set of encoded data and management information to manage the encoded stream being processed from a storage medium, the encoded data including a video signal representing video and an audio signal representing audio that have been encoded by a predetermined encoding technique; a decoding section for decoding the encoded stream into the video signal and the audio signal; an extracting section for extracting aspect information, which is defined for each said set of the encoded data to control the aspect ratio of the video, from the management information; and a superposing section for outputting the aspect information after having superposed the aspect information on the video signal.

A data playback method according to the present invention includes the steps of: reading an encoded stream as a set of encoded data and management information to manage the encoded stream being processed from a storage medium, the encoded data including a video signal representing video and an audio signal representing audio that have been encoded by a predetermined encoding technique; decoding the encoded stream into the video signal and the audio signal; extracting aspect information, which is defined for each said set of the encoded data to control the aspect ratio of the video, from the management information; and outputting the aspect information that has been superposed on the video signal.

Another data storage apparatus according to the present invention includes: a video signal receiving section for receiving a video signal representing video and copy information indicating whether the video may or may not be recorded; an audio signal receiving section for receiving an audio signal representing audio; a detecting section for detecting the copy information from the video signal; a stream generating section for generating encoded data by encoding the video and audio signals by a predetermined encoding technique and also generating an encoded stream as a set of the encoded data; management information generating section for generating management information to manage the encoded stream being processed, the management information including copy control information that includes copy protection information, showing a method of protecting the encoded stream from being copied, and status information indicating whether the copy protection information is valid or not; and a writing section for storing the management information and the encoded stream as at least one file on a storage medium if the copy information indicates that the video may be copied.

A storage medium according to the present invention stores thereon data that can be read by a data playback apparatus. The data has a data structure consisting of moving picture data, in which an encoded stream is included as a set of encoded data, and management information to manage the encoded stream being processed in the moving picture data. The encoded data is obtained by encoding a video signal, representing video and aspect information to control the aspect ratio of the video, and an audio signal representing audio by a predetermined encoding technique. The management information includes the aspect information to control the aspect ratio of the video for each said set of encoded data.

### BRIEF DESCRIPTION OF DRAWINGS

FIG. 1 shows a format for an MP4 file 1.

FIG. 2 shows another format for an MP4 file.

FIG. 3 shows a specific format for the MP4 file 1.

FIG. 4 is a block diagram of a data processor 10 according to the present invention.

FIG. 5 is a block diagram of the moving picture stream generating section 101.

FIG. 6 shows the data structure of a moving picture file stored on the optical disc 131.

FIG. 7 shows a more detailed data structure of the moving picture stream 11.

FIG. 8 is a flowchart showing a procedure to generate management information.

FIG. 9 is a flowchart showing a procedure to generate aspect control information.

FIG. 10 shows an access information management area and an aspect control information management area of the management information 13.

FIG. 11 shows the atom structure of the management information 13.

FIG. 12(a) shows the data structure of the time series data file 12, and FIG. 12(b) shows the respective atoms of a management file 14 corresponding to the file shown in FIG. 12(a).

FIG. 13 shows a more specific atom structure of Sample Description Atom 311 in Sample Table Atom 18.

FIG. 14 shows the data structure of the Encoding Mode Flag field 518.

FIG. 15(a) shows the ranges to which respective pieces of aspect control information are applied, and FIG. 15(b) shows Sample Description Entries 515a to 515c in which those pieces of aspect control information are described.

FIG. 16 shows an example in which the access information and the aspect control information are managed in the information sharing/management area of the management information 13.

FIG. 17 shows an example in which the aspect control information is managed in every interval, defined by a plurality of chunks, in the aspect control information management area.

FIG. 18 shows an example in which the aspect control information is stored in a different atom from Sample Table Atom 512.

FIGS. 19(a) through 19(d) show a correlation between the data structures of video frames, video samples and video chunks for generating a moving picture stream according to a second preferred embodiment and that of a moving picture file generated.

FIG. 20 shows the data structure of a moving picture file stored on the optical disc 131.

FIGS. 21(a) through 21(e) show a correlation between the data structures of an audio stream, audio chunks, a video stream and video chunks for generating a moving picture stream according to the second preferred embodiment and that of a moving picture file generated.

FIG. 22 shows data fields defined for the management information.

FIG. 23 shows the data structure of the field 50 for defining the aspect-related information.

FIGS. 24(a) and 24(b) show the data structures of the management information for managing the aspect ratio change point.

FIG. 25 shows a format in which link information L is provided in the management information such that an MPEG2-PS file, storing a moving picture stream, is identified by the link information L.

FIG. 26 shows a format in which the link information L provided within a management file 53 provides a link to an MPEG-2 file 54 storing an elementary stream (ES).

FIG. 27 shows a format in which the aspect control information is defined as ASPI management file 57 and is associated with a management file 55 and an MPEG-2 file 56 by the file name.

FIG. 28 is a flowchart showing a procedure to generate copy control information.

FIG. 29 shows a Copy Control Information Atom field 512 provided in User Data Atom 511.

FIG. 30 shows the data structure of the Copy Control Information Atom field 512.

FIG. 31 shows a management file 60 in which a decoding key K is stored within the management information and an MPEG-2 file 61 in which a moving picture stream, decodable with the decoding key K, is stored.

### BEST MODE FOR CARRYING OUT THE INVENTION

Hereinafter, preferred embodiments of a data processor according to the present invention will be described with reference to the accompanying drawings.

### Embodiment 1

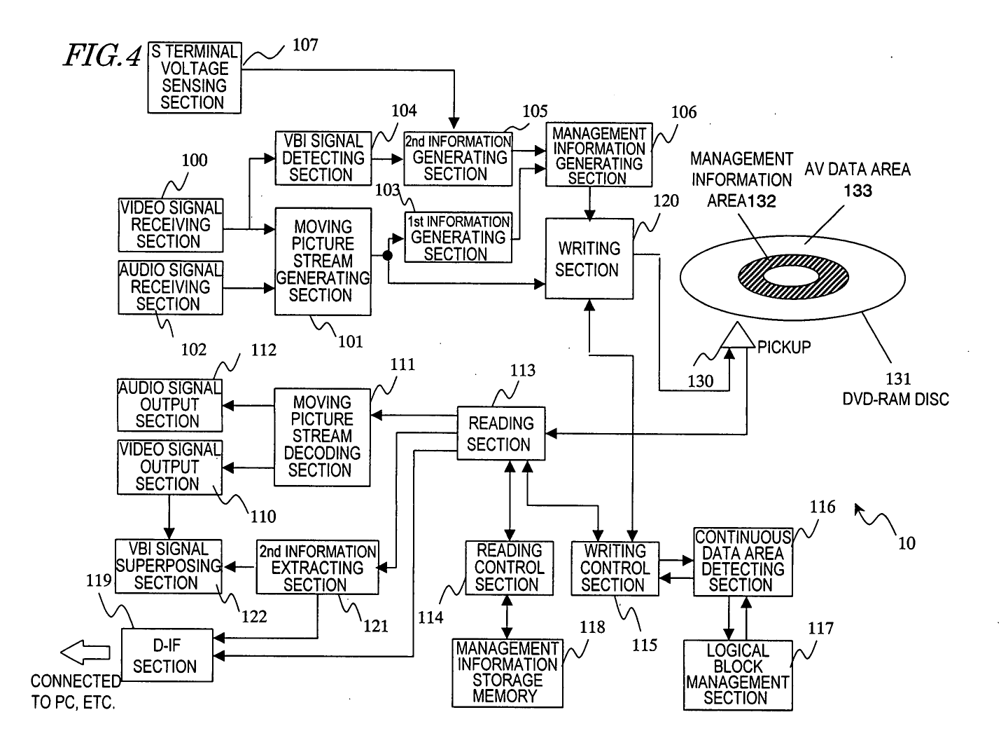

FIG. 4 shows an arrangement of functional blocks for a data processor 10 according to the present invention. The data processor 10 has the functions of recording and reproducing data. More specifically, the data processor 10 can encode a video signal and an audio signal and store them as a data file with a predetermined data structure on a storage medium 131. The data file defines an aspect ratio, copy control information about copy control and so on for each set of encoded data, which is defined based on the video playback duration, the amount of data (i.e., data size) and other parameters. Meanwhile, the data processor 10 can also retrieve a data file stored on the storage medium 131 and present video at the defined aspect ratio or output the data file to a PC, for example. In the following description, an MP4 file will be mainly used as a data file. However, even a QuickTime file may also be used as a data file and the same effects are achieved.

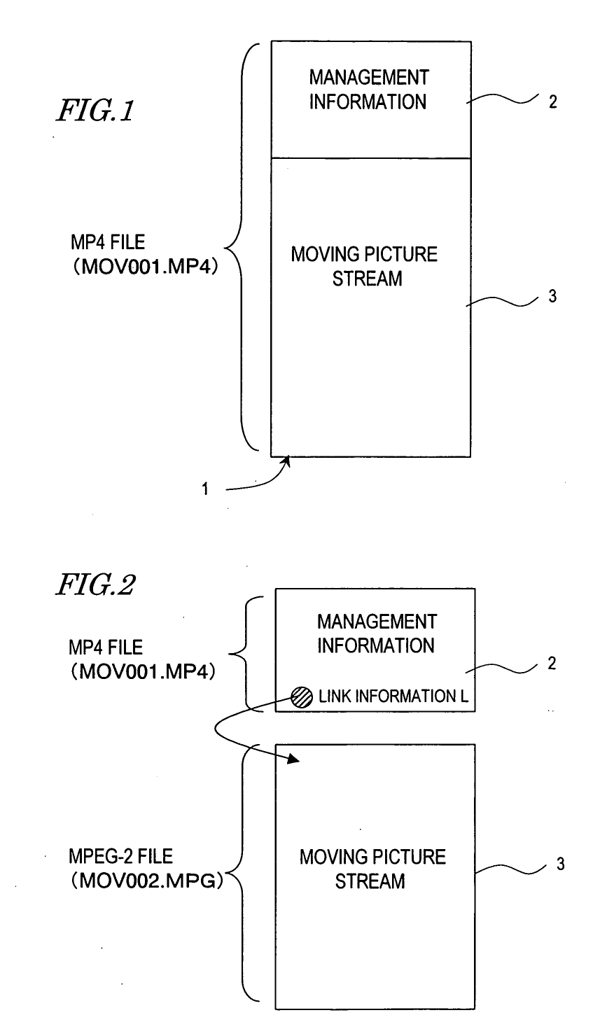

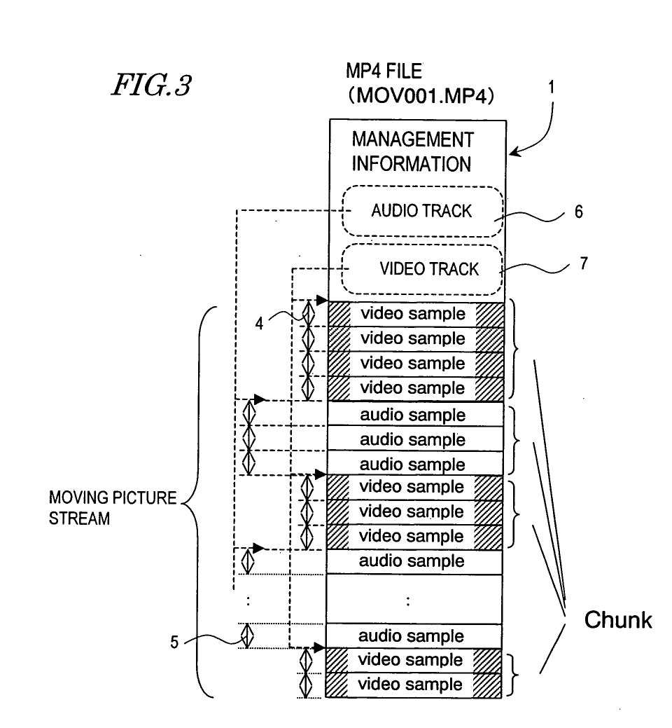

The storage medium 131 is supposed herein to be an optical disc. The optical disc is not an essential component for the data processor 10 but is shown in FIG. 1 for convenience sake. As to optical discs, there are various standards. Among those standards, DVD-RAM discs, MOs, DVD-Rs, DVD−RWs, DVD+RWs, CD-Rs and CD-RWs are well known. It should be noted that the storage medium 131 may be a removable storage medium other than an optical disc (e.g., a semiconductor memory card) and may also be a hard disk, a semiconductor memory or any other component that forms an integral part of the data processor 10.

Hereinafter, respective components of the data processor 10 and then the operation thereof will be described.

First, the respective components of the data processor 10, contributing to the recording function thereof, will be described. The data processor 10 includes a video signal receiving section 100, a moving picture stream generating section 101, an audio signal receiving section 102, a first information generating section 103, a VBI signal detecting section 104, a second information generating section 105, a management information generating section 106, an S terminal voltage sensing section 107, a writing section 120, a writing control section 115, a continuous data area detecting section 116 and a logical block management section 117.

The video signal receiving section 100 receives a video signal on a broadcasting wave, for example. In the video signal, a VBI signal which carries aspect information, copy control information, closed caption data and so aon, is multiplexed on a signal representing video itself. The audio signal receiving section 102 receives an audio signal representing audio.

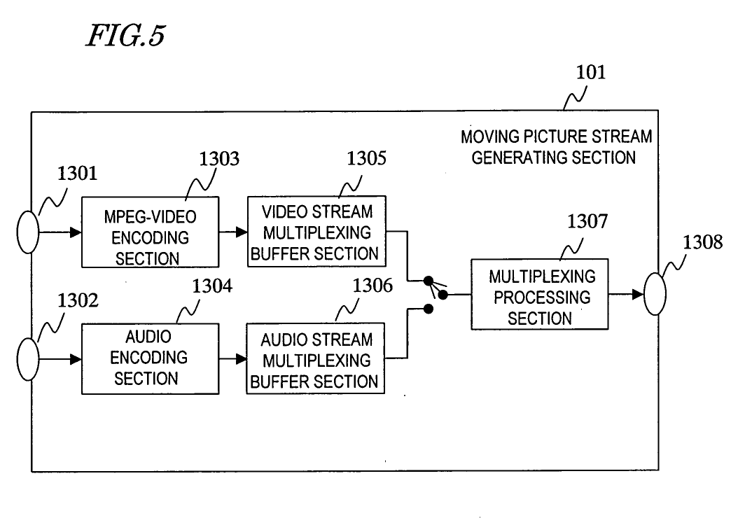

The moving picture stream generating section 101 encodes and multiplexes the video signal and audio signal by predetermined encoding techniques (e.g., in accordance with the MPEG2-Video and AC-3 standards, respectively), thereby generating a moving picture stream. The moving picture stream includes at least a video signal. FIG. 5 shows a more detailed arrangement of functional blocks for the moving picture stream generating section 101. An MPEG-Video encoding section 1303 encodes a video signal, received at a video signal input terminal 1301, thereby generating an MPEG-2 video stream. A video stream multiplexing buffer section 405 temporarily stores the MPEG-2 video stream. An audio encoding section 1304 encodes an audio signal, received at an audio signal input terminal 1302, thereby generating an audio stream. An audio stream multiplexing buffer section 1306 temporarily stores the audio stream. A multiplexing processing section 1307 alternately reads these two streams from the buffers on a chunk-by-chunk basis, for example, thereby multiplexing those two streams together and outputting it as a moving picture stream through a moving picture stream output terminal 1308. The moving picture stream is composed as a mixture of video data and audio data. Furthermore, the moving picture stream generating section 101 outputs information about how the respective streams were arranged to make up the moving picture stream.

The first information generating section 103 generates access information for use to control reading of the moving picture stream as first control information. As used herein, the “access information” means information about storage locations for accessing samples at random (e.g., address values of a time series data file).

The VBI signal detecting section 104 detects a VBI signal from the video signal and passes the VBI signal detected to the second information generating section 105. Alternatively, the VBI signal detecting section 104 may detect the aspect information, copy control information and other types of information from the VBI signal in the video signal, and provide only the signal about that information to the second information generating section 105. Based on the aspect information, copy control information and other types of information included in the VBI signal, the second information generating section 105 generates second control information. The copy control information includes copy protection information and status information indicating whether the copy protection information is valid or not. The S terminal voltage sensing section 107 senses a voltage applied to the S terminal (not shown) of the data processor 10. The second information generating section 105 may determine the aspect ratio on receiving a sensing signal from the S terminal voltage sensing section 107.

The management information generating section 106 generates management information for managing the processing of the encoded stream based on the first and second control information. As will be described later, the management information includes aspect information and/or copy control information for each set of encoded data, which is defined by the video playback duration and the amount of data (or data size). As used herein, the “set of encoded data” refers to a video object unit in a DVD, corresponding to a video playback duration of about 0.4 to 1 second, a sample defined on the basis of a frame of 1/30 second, or a chunk as a set of multiple samples. A more detailed function of the management information generating section 106 will be described later.

The writing control section 115 controls the operation of the writing section 120. In accordance with the instruction from the writing control section 115, the continuous data area detecting section 116 checks the availability of sectors being managed by the logical block management section 117, thereby detecting a physically continuous unused area. Then, the writing section 120 gets the management information and moving picture stream written on the optical disc 131 by a pickup 130.

Next, components and operation of the data processor 10, contributing to the playback function thereof, will be described. The data processor 10 includes a video signal output section 110, a moving picture stream decoding section 111, an audio signal output section 112, a reading section 113, a reading control section 114, a management information storage memory 118, a D-IF section 119, a second information extracting section 121 and a VBI signal superposing section 122.

A plurality of management files, which were stored in, and have been read in advance from, the management information area 132 of the optical disc 131, are stored in the management information storage memory 118. During a playback operation, the reading control section 114 reads a management file (management information), associated with a user's designated times series data file (moving picture stream file), from the management information storage memory 118 and plays back the moving picture stream of the time series data file by using the access data of the management file in question. As to the moving picture stream, the data thereof is read by the pickup 130 and retrieved as an encoded data signal by the reading section 113. The moving picture stream decoding section 111 decodes the encoded data signal, thereby outputting a video signal and an audio signal to the video signal output section 110 and the audio signal output section 111, respectively. Furthermore, the second information extracting section continuously reads aspect control information, copy control information and other types of information associated with the retrieved portion. Then, while the video is being played back, the VBI signal superposing section 122 either adjusts the aspect ratio of the output video or superposes and outputs the copy control information in accordance with those types of information.

The data processor 10 may output an MP4 file or QuickTime file that has been read out from the optical disc 131 (which will be referred to herein as a “moving picture file”) to an external device by way of the D-IF section 119. In that case, the reading section outputs the moving picture file, while the second information extracting section 121 extracts the second control information from the management information of the moving picture file and checks by the copy control information, which is a portion of the management information, whether or not the moving picture file can be copied. If the answer is YES, then the moving picture file, as well as the copy control information, is converted by the D-IF section 119 into a format compliant with an interface standard, and then output. For example, if the D-IF section 119 is an interface compliant with the IEEE 1394 standard, then the D-IF section 119 converts the copy control information extracted into a format compliant with the IEEE 1394 standard and then outputs it. In this manner, the copy control information as defined by the management information is extracted from the management file stored on the optical disc 131, incorporated into a data stream, and then output through the digital interface. As a result, a data stream, guaranteeing copyright protection, can be output.

Optionally, play list information may be stored on the optical disc such as a DVD-RAM. The “play list information” is information about the order in which part or all of multiple moving picture streams are played back. A play list playback function of playing back moving picture streams in accordance with the play list information is a characteristic function when a randomly accessible optical disc is used. In playing back a number of moving picture streams continuously one after another, required files are preferably selected in advance from a group of management information files stored in the management information storage memory 118. Then, a play list for playing a plurality of moving picture streams continuously can be compiled.

Next, it will be described how the data processor 10 performs its recording operation.

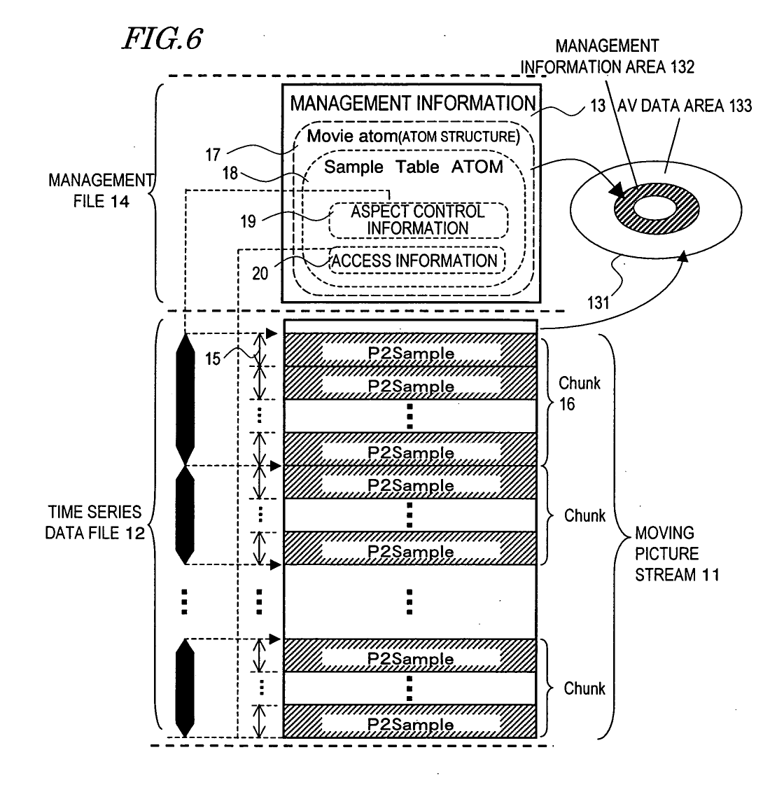

As described above, the data processor 10 stores the management information and a moving picture stream on the optical disc 131, thereby generating a moving picture file. Thus, the data structure of the moving picture file, obtained as a result of the recording operation of the data processor 10, will be described first. FIG. 6 shows the data structure of a moving picture file stored on the optical disc 131. The moving picture file includes a time series data file 12 with a moving picture stream 11 and a management file 14 with management information 13. The time series data file 12 is written on an AV data area 133 of the optical disc 131, while the management file 14 is written on the management information area 132 of the optical disc 131.

The moving picture stream 11 may be a system stream as defined by the MPEG-2 system standard (ISO/IEC 13818-1), for example. Three types of system streams, namely, a program stream (PS), a transport stream (TS) and a PES stream, are defined. However, the MPEG-2 system standard defines no data structure to store the management information (including access information, special playback information and recording date/time information) for these system streams.

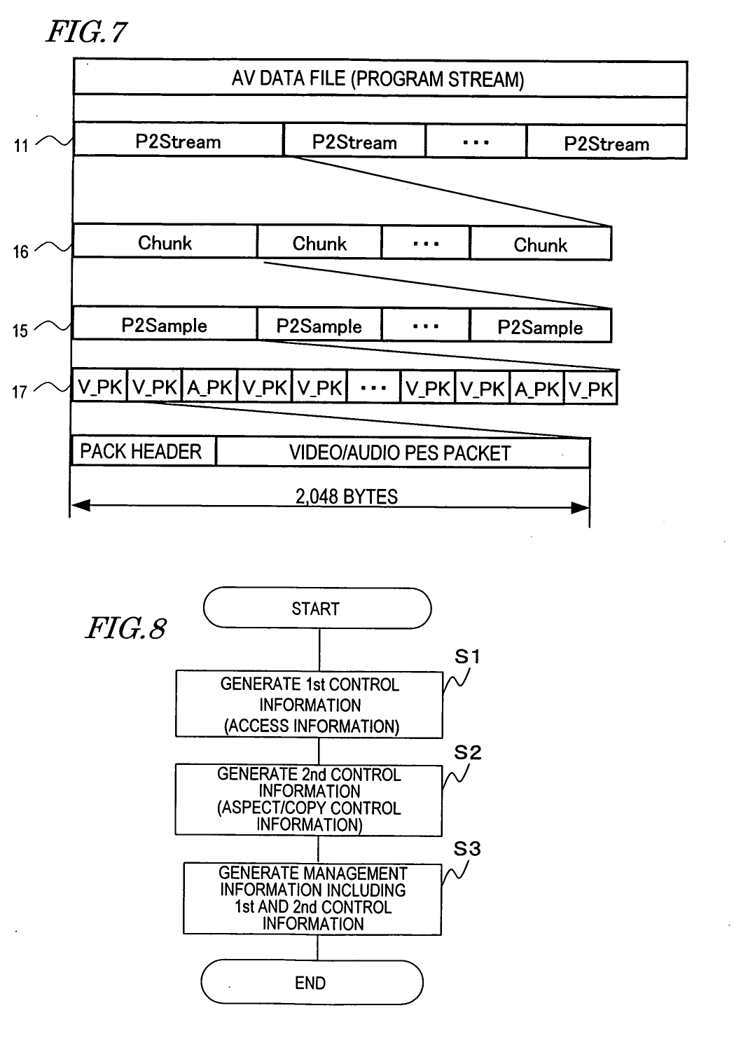

The moving picture stream 11 includes a plurality of samples (P2Samples) 15. Each of these samples 15 is composed as a mixture of video data and audio data and may be defined by the video playback duration, the amount of data (or data size) or any other parameter. For example, each sample 15 may include video data in an amount corresponding to a video playback duration of about 0.4 to 1 second as in a video object unit (VOBU) in a DVD. A set of one or more samples 15 will be referred to herein as a “chunk 16”. FIG. 7 shows a more detailed data structure of the moving picture stream 11. Each sample 15 includes a plurality of video packs V_PK and a plurality of audio packs A_PK. Each pack consists of a pack header and a PES packet, in which video or audio data is stored, and has a constant data size of 2,048 bytes. In the moving picture stream shown in FIG. 7, the video data and audio data may be combined into a moving picture stream track and may be managed collectively as the single track.

Referring back to FIG. 6, the management information 13 includes sample-by-sample access information 20 and aspect control information 19. These pieces of information are described in Sample Table Atom 18 in Movie Atom 17 within the management information 13. In other words, the sample is managed as the minimum management unit in the Sample Table Atom 18 and the access information 20 representing the data storage location and so on is described for each sample. On the other hand, the aspect control information 19 is described either on a sample basis or on a chunk basis, and is commonly applied to the video in respective units. It should be noted that the “sample” 15 and “chunk” 16 are just units of the moving picture stream 11 to be managed with the management information 13 and the data of the moving picture stream 11 is not always defined as physically divided ones.

Next, it will be described by what reference the samples 15 and chunk 16 are defined for the management information 13. For example, suppose video data and audio data, corresponding to a video playback duration of about 0.4 to 1 second, is a single sample (P2Sample) 15. The access information of each sample is described in the management information 13. And when an aspect ratio that is commonly applicable to a series of pictures is determined, an interval corresponding to those pictures is treated as a single chunk 16 and aspect control information 19, commonly applied to all samples within each chunk, is defined. The “series of pictures” may be continuous video taken with a camcorder in a single session that starts at a recording start point and ends at a recording end point. In the management information 13, the access information may be defined for each chunk. In this example, an interval corresponding to a series of pictures with the same aspect ratio is supposed to be the reference by which the chunk is defined. According to the present invention, however, the chunk may be defined by another reference that has no particular correlation with this.

Based on the data structure and reference described above, the moving picture stream generating section 101 and management information generating section 106 generate the moving picture stream 11 and the management information 13, respectively.

Hereinafter, the management information generating processing will be described in further detail. FIG. 8 shows a procedure to generate the management information. First, in Step S1, the first information generating section 103 creates first control information (i.e., access information). Next, in Step S2, the second information generating section 105 creates second control information (aspect control information and/or copy control information). Then, in Step S3, the management information generating section 106 generates the management information 13 including the first and second control information.

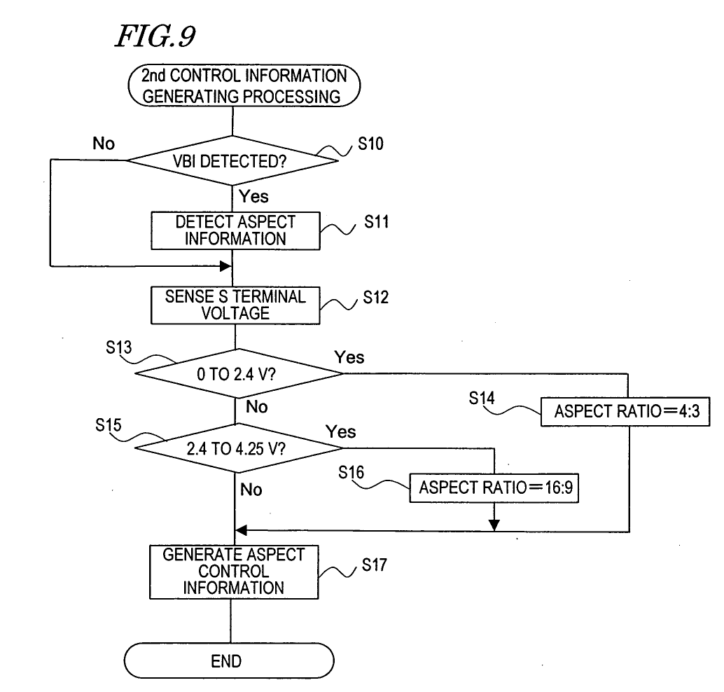

The processing step S2 of generating the second control information shown in FIG. 8 will be described in further detail with reference to FIG. 9. In the following example, the processing of generating the aspect control information as the second control information will be described. FIG. 9 shows a procedure to generate the aspect control information. First, in Step S10, the VBI signal detecting section 104 determines whether or not it has detected the VBI signal. If the answer is NO, then the process advances to Step S12. On the other hand, if the answer is YES, then the second information generating section 105 detects the aspect information multiplexed in the VBI signal in Step S11.

In the next step S12, the second information generating section 105 gets the voltage at the S terminal sensed by the S terminal voltage sensing section 107 because the S terminal voltage can be used to specify the aspect ratio. More specifically, (1) if the S terminal voltage falls within the range of GND of 0 V to 2.4 V, then the video aspect ratio of the component signal will be 4 to 3. On the other hand, (2) if the S terminal voltage falls within the range of 2.4 V to 4.25 V, then the video aspect ratio of the component signal will be 16 to 9 (which is a so-called “wide” screen ratio). However, if the S terminal voltage is in the range of 4.25 V to VDD of 5 V, then it is determined that no voltage has been applied to the S terminal yet or that there is no S terminal in this device. And no particular aspect ratio will be defined in that case. Thus, it is necessary to judge which of the two situations (1) and (2) is true.

In Step S13, the second information generating section 105 determines whether or not the S terminal voltage falls within the range of 0 V to 2.4 V. If the answer is YES, then the process advances to Step S14, in which the second information generating section 105 sets the aspect ratio to 4 to 3. On the other hand, if the answer is NO, then the second information generating section 105 further determines, in Step S15, whether or not the S terminal voltage falls within the range of 2.4 V to 4.25 V. If the answer is YES, then the process advances to Step S16, in which the second information generating section 105 sets the aspect ratio to 16 to 9. If the answer is YES, then the process advances to Step S16, in which the second information generating section 105 sets the aspect ratio to 16 to 9.

Thereafter, in Step S17, the management information generating section 106 generates aspect control information based on either the aspect information extracted from the VBI signal or the aspect ratio specified, and describes that information in the management information 13.

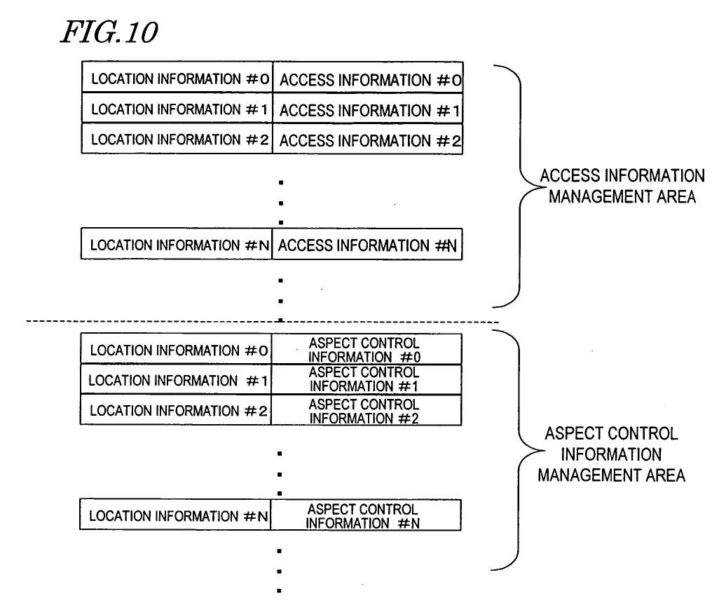

The aspect control information, generated as a result of the processing described above, is stored, along with other types of information, in the management information 13 as shown in FIG. 10, for example. FIG. 10 shows an access information management area and an aspect control information management area of the management information 13. In the access information management area, the location information and access information of each sample are stored so as to be associated with each other. On the other hand, in the aspect information management area, the location information and aspect control information of each sample are stored so as to be associated with each other. For example, the “location information” may be defined by the serial sample number, which is given to the respective samples consecutively from the beginning of the data and through a number of chunks, the chunk number as counted from the top chunk, or information about the playback duration as counted from the beginning.

Next, a specific data structure of the management information 13 generated by the management information generating section 106 will be described. The data structure of the management information 13 is a layered one. The respective fields making up the data structure are called “Atoms” according to the QuickTime™ file format standard defined by Apple Corporation but called “Boxes” according to the ISO Base Media file format of the MP4 standard. Most of the specifications of the MP4 standard are defined based on the QuickTime™ file format of Apple Corporation. Although some fields have different definitions or names, the contents of the specifications are mostly the same between the two formats. In the following example, the atom structure compliant with the QuickTime standard will be described. Generally speaking, however, any field may be adapted to the MP4 standard by replacing the field's name “Atom” with “Box”.

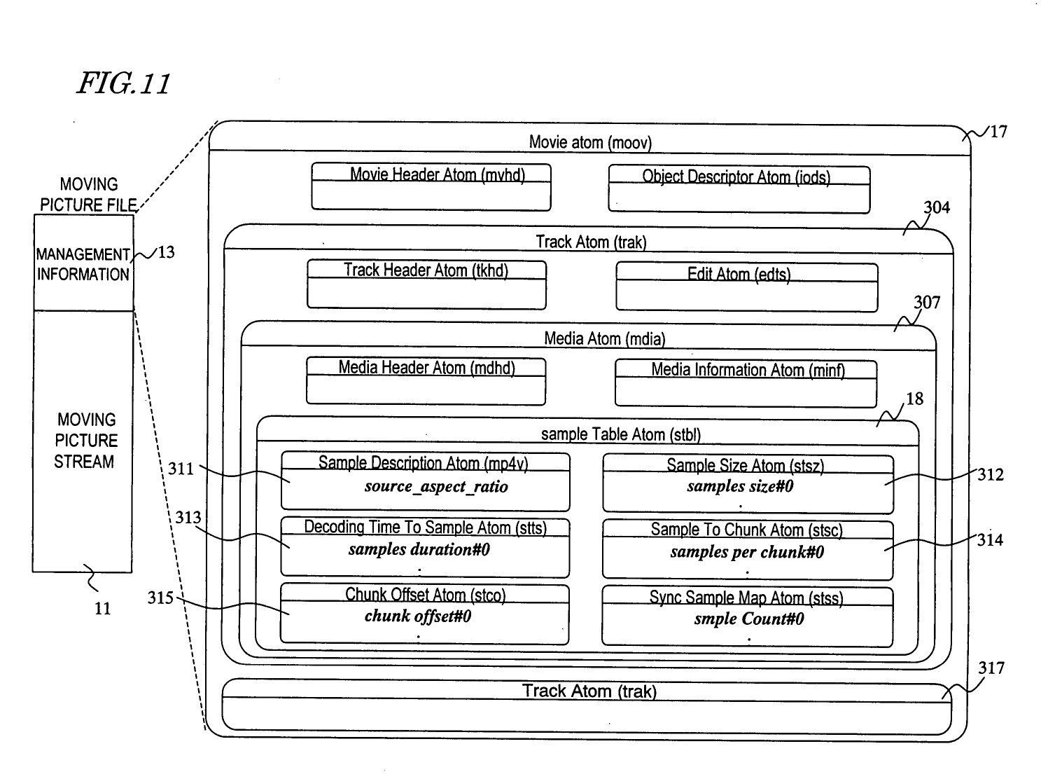

The management information generating section 106 generates the management information 13 in accordance with the atom structure to be described below. FIG. 11 shows the atom structure of the management information 13. The management information 13 is defined by Movie Atom 17. In Movie Atom 17, information about each encoded video or audio data, including the data size, the address of the data storage location, and a time stamp showing the presentation timing, is described independently on a frame-by-frame basis. Track Atom 304 is defined for the video data. Among various atoms included in Track Atom 304, Sample Table Atom 18 in Media Atom 307 will be described herein. Media Atom 307 is a field to store information about the encoded stream. Track Atom 317, for example, is defined for the audio data.

Sample Table Atom 18 further includes a plurality of atom fields. Among those atom fields, Sample Description Atom 311, Sample Size Atom 312, Decoding Time To Sample Atom 313, Sample To Chunk Atom 314 and Chunk Offset Atom 315 will be herein paid attention to.

In Sample Description Atom 311, the aspect control information source_aspect_ratio applied to the video in the sample is defined. In Sample Size Atom 312, the data size of that sample is defined. In Decoding Time To Sample Atom 313, the video playback duration of that sample is defined. In Sample To Chunk Atom 314, the number of samples included in one chunk is defined. In Chunk Offset Atom 315, the top location (offset) of each chunk as counted from the top of the time series data file is defined. It should be noted that “#0” added to each of the atoms 312 to 315 indicates that the data is associated with the 0^{th} sample or chunk. Thus, the data associated with the first, second ones and so on will follow them although not shown in FIG. 11.

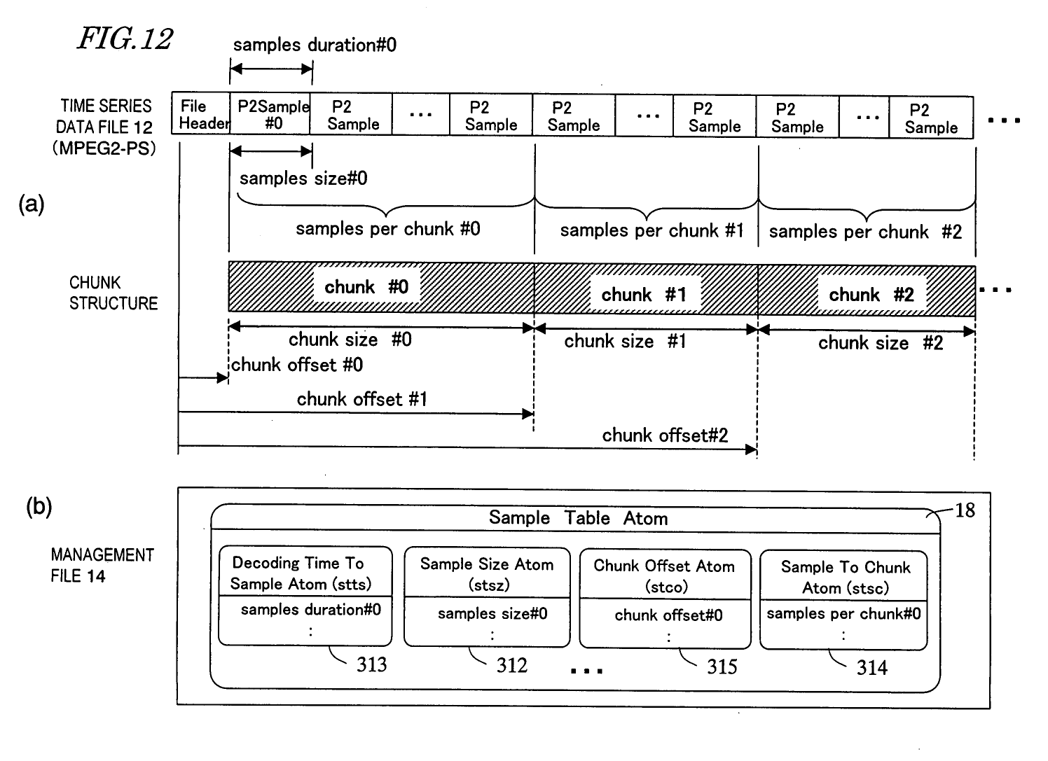

FIG. 12(a) shows the data structure of the time series data file 12, while FIG. 12(b) shows the respective atoms of a management file 14 corresponding to the file shown in FIG. 12(a). The field of each of the atoms 312 to 315 shown in FIG. 12(b) defines the data size, playback duration or any other parameter of the interval with the same name shown in FIG. 12(a). For example, “samples size #0” shown in Sample Size Atom 312 defines the data size of P2Sample #0, which is arranged at the top (i.e., in the 0^{th} order) of the data file 12. As shown in FIGS. 12(a) and 12(b), the respective samples, chunks and so on that make up the time series data 12 are defined by the atoms within the management information in the management information file 14.

FIG. 13 shows a more specific atom structure of Sample Description Atom 311 in Sample Table Atom 18. Sample Description Atom 311 includes one or more Sample Description Entries 515. Each Sample Description Entry 515 is provided for its associated chunk and further includes an Encoding Mode Flag field 518. The aspect control information 19 is described in a field 519 of the Encoding Mode Flag field 518.

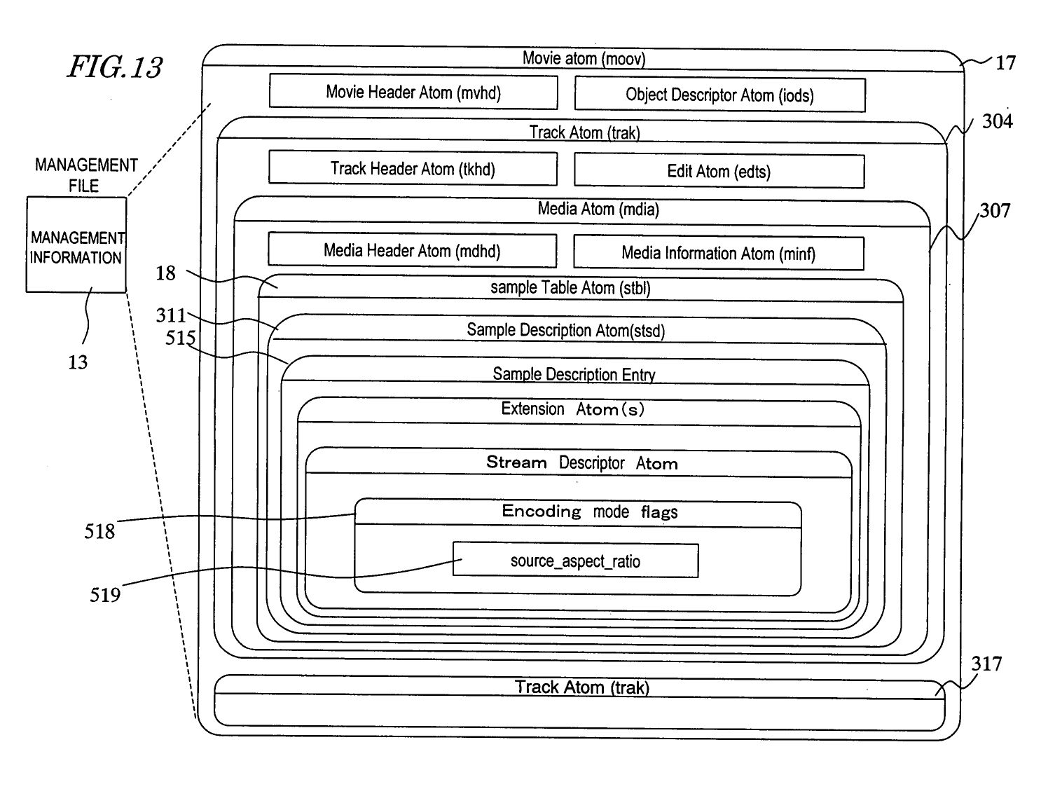

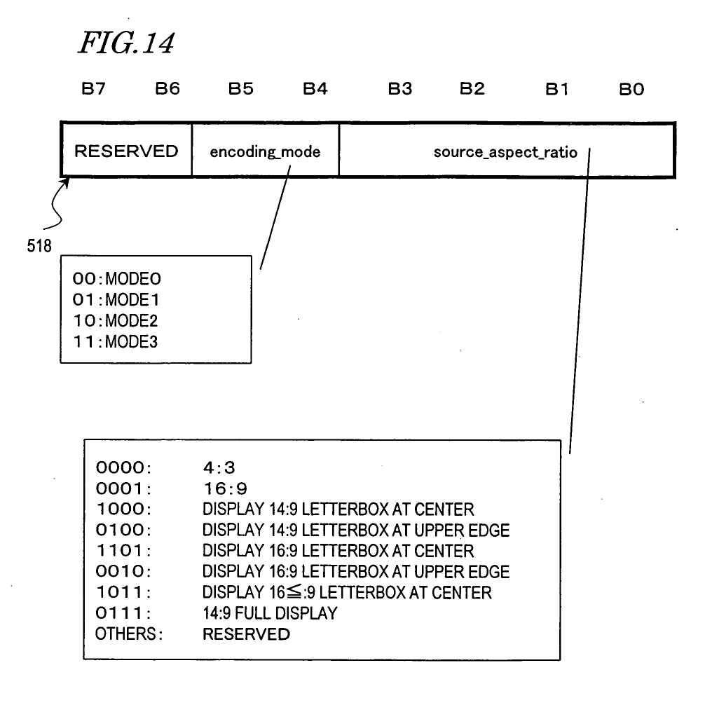

FIG. 14 shows the data structure of the Encoding Mode Flag field 518. The Encoding Mode Flag field 518 is composed of 8 bits. Among these 8 bits, the least significant four bits B0 through B3 define the aspect control information 19 (source_aspect_ratio), the next least significant two bits B4 and B5 define the encoding mode encoding_mode and the most significant two bits are reserved. The aspect control information 19 defines at least eight aspect ratios shown in FIG. 14 by the least significant four bits. It should be noted that the “aspect ratio” includes herein a video display location.

FIG. 15(a) shows the ranges to which respective pieces of aspect control information are applied, while FIG. 15(b) shows Sample Description Entries 515a to 515c in which those pieces of aspect control information are described. As shown in FIG. 15(a), aspect control information #n (where n is an integer) is applied to chunk #n. Thus, every video within the chunk #n is presented at the same aspect ratio.

A data structure for defining the aspect control information 19 has been described. Based on this data structure, the data processor 10 generates the management file 14 and stores the file 14, along with the times series data file 12, on the optical disc 131. Also, the data processor 10 reads and analyzes the management file 14 stored, thereby playing back the video and audio from the moving picture stream 11 within the time series data file 12 at the aspect ratio specified by the aspect control information 19.

It should be noted that the data structures described above are just examples. Thus, any other data structure may be adopted and the aspect control information and so on may be described in different atoms as well.

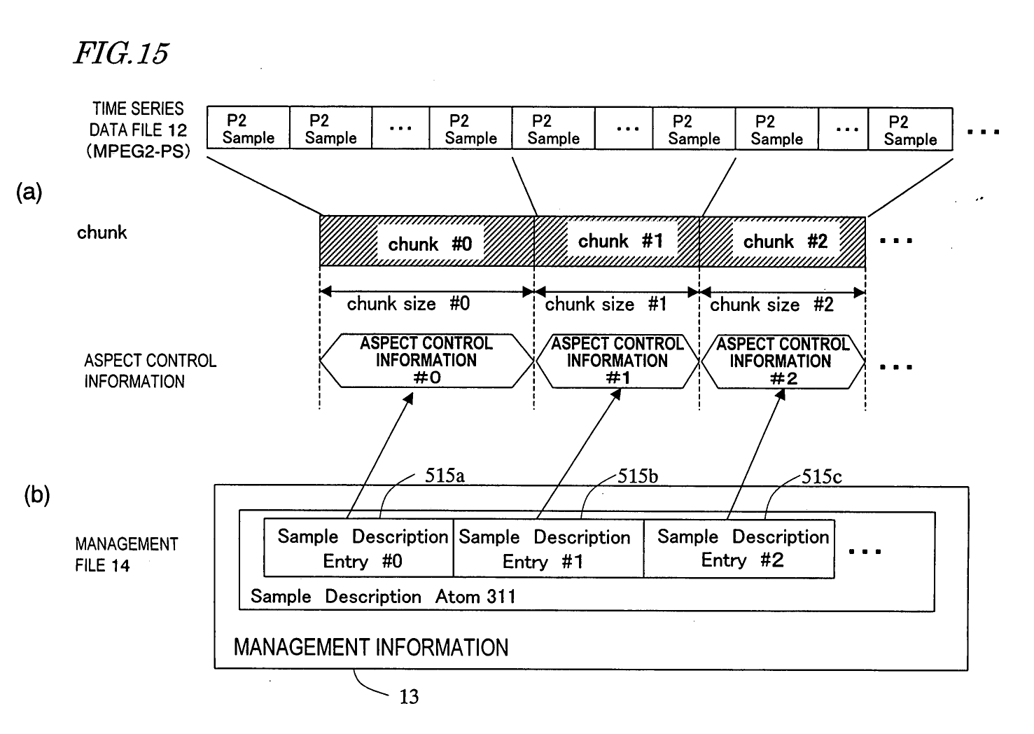

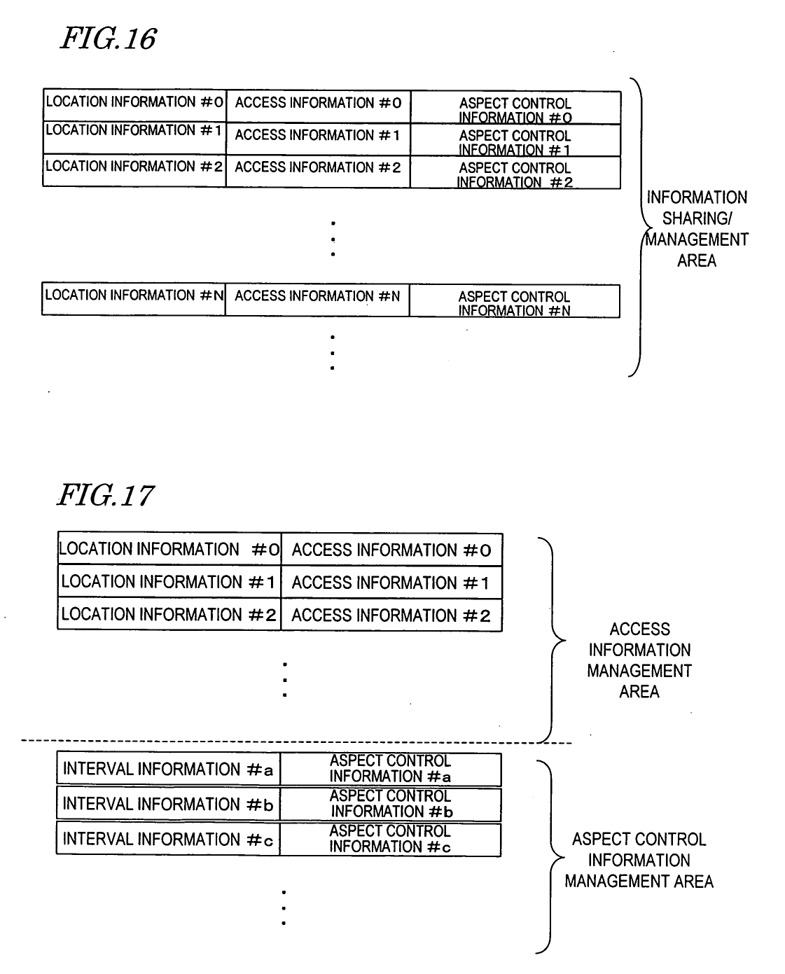

For example, in the example described with reference to FIG. 10, the access information and the aspect control information are supposed to be separately managed in the access information management area and the aspect control information management area, respectively. However, these pieces of information may be managed by any other method. FIG. 16 shows an example in which the access information and the aspect control information are managed in the information sharing/management area of the management information 13. On the other hand, FIG. 17 shows an example in which the aspect control information is managed in every interval, defined by a plurality of chunks, in the aspect control information management area. The aspect control information 19 may be managed as shown in FIG. 17 because the aspect control information 19 does not change one chunk after another like the access information but is often unchanged over a plurality of chunks. Thus, the change point of the aspect control information is managed and an interval (consisting of a number of chunks) in which a single piece of aspect control information is valid is defined by the interval information. By adopting such a management method, there is no need to provide copy control information for every chunk, the data size of the aspect control information can be reduced, and the file size of the management file can be cut down.

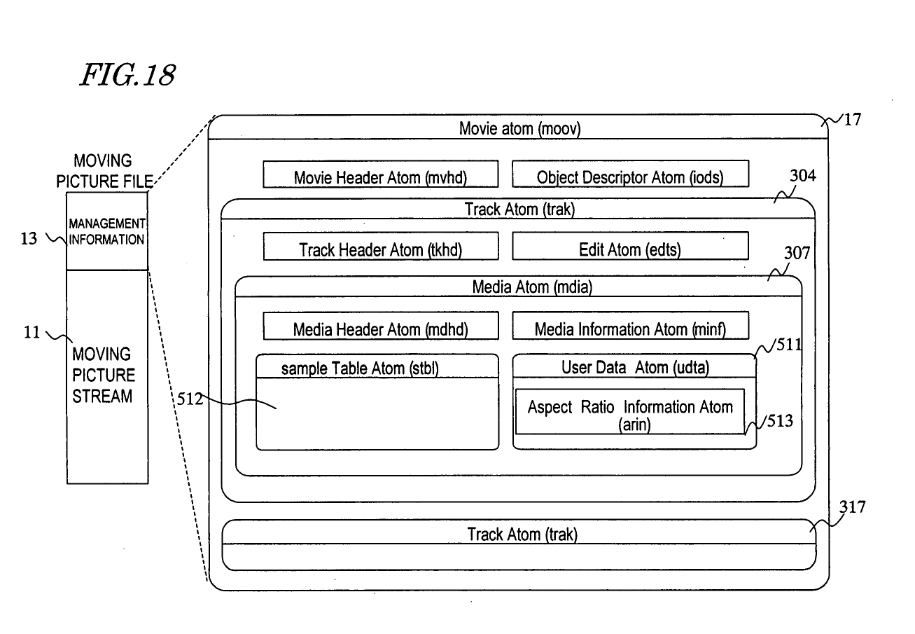

FIG. 18 shows an example in which the aspect control information is stored in a different atom from Sample Table Atom 512. The aspect control information is defined in Aspect Ratio Information Atom 513 in User Data Atom 511 within Media Atom 307. In User Data Atom 511, the user data may be described freely in the data structure compliant with either the QuickTime standard or the MP4 standard. According to these standards, however, User Data Atom 511 does not have to be provided within Media Atom 307. Alternatively, User Data Atom 511 may be provided, along with Media Atom 307, within Track Atom 304, for example.

By defining the aspect control information in the management information, which is provided separately from a moving picture stream, the processing load on the player, which is playing back the stream, can be reduced. The player may extract the aspect control information from the management information before playing back the moving picture stream, for example. Thus, the player can know the aspect ratio of the video in advance. Consequently, the player does not have to perform the aspect control in parallel with the moving picture stream processing. That is to say, the processing load thereof can be lightened and the processing resources of the player can be assigned to other types of processing effectively.

It should be noted that the data processor 10 can also store MP4 file management information, compliant with the MPEG-4 system standard (ISO/IEC 14496-1), in addition to the management information described above. Thus, even if an MP4 file were output through the D-IF section 308 to a PC or any other external device, a playback application program for a PC, which accepts only a normal MP4 file, or a player, compatible with just a normal MP4 file, could also play the MP4 file, too.

### Embodiment 2

Hereinafter, a data processor according to a second preferred embodiment of the present invention will be described. The data processor of this second preferred embodiment has the same configuration as the data processor 10 of the first preferred embodiment shown in FIG. 4. Thus, the description of the respective components of the data processor will be omitted herein. In the following preferred embodiment, an atom structure compliant with the QuickTime standard will be described as an example. Generally speaking, however, any field may be adapted to the MP4 standard by replacing the field's name “Atom” with “Box”.

The data processor 10 of this preferred embodiment is supposed to process a moving picture stream having a different data structure from that of the moving picture stream 11 shown in FIG. 6. However, as in the file of the first preferred embodiment, aspect control information, access information and other types of information are defined as the management information and the processing of the moving picture stream is managed in accordance with the management information.

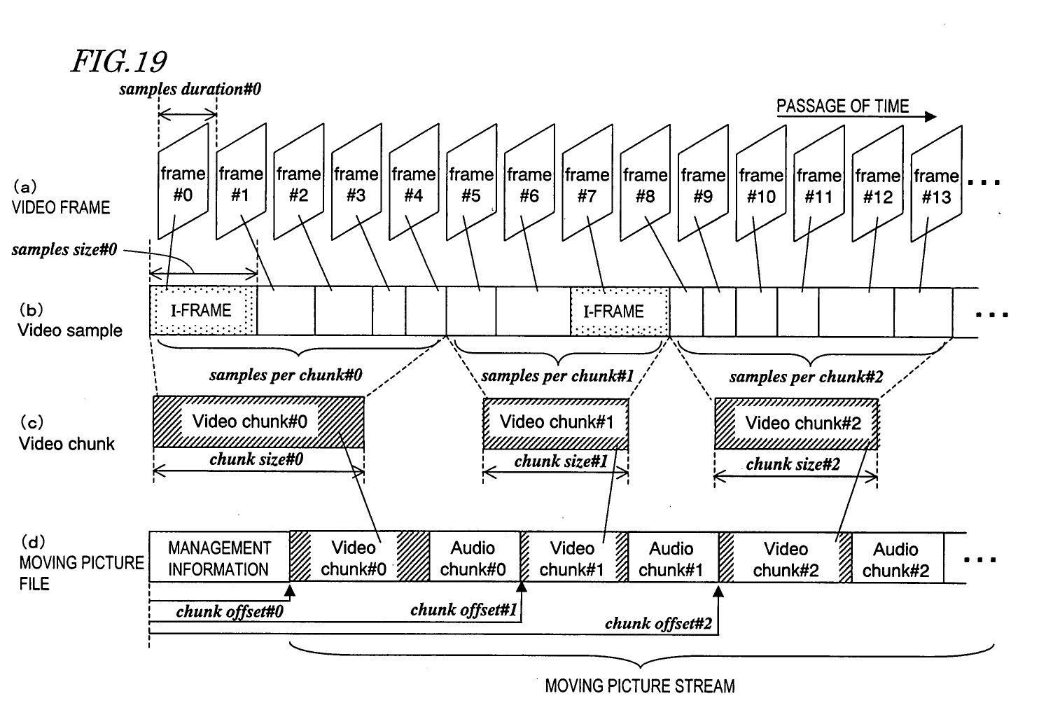

FIGS. 19(a) through 19(d) show a correlation between the data structures of video frames, video samples and video chunks for generating a moving picture stream according to this preferred embodiment and that of a moving picture file generated (e.g., an MPEG-4 file or a QuickTime file). Specifically, FIG. 19(a) shows a plurality of video frames that make up the video. FIG. 19(b) shows a plurality of video samples, each associated with a video frame. And FIG. 19(c) shows a plurality of video chunks, each consisting of one or more samples.

Only the video-related data is shown in FIGS. 19(a) through 19(c), but audio-related frames, samples and chunks are separately generated as indicated by “Audio Chunks” in FIG. 19(d). For example, in AC-3 audio with a sampling frequency of 48 kHz and a rate of 256 kbps, one audio frame refers to 1,536 samples in total. It should be noted that even if the samples and chunks are defined for both video data and audio data alike, the management information defines the data size (samples size) and playback duration (samples duration) for each sample or chunk and also defines the number of samples in a chunk (samples per chunk) and chunk offset (chunk offset).

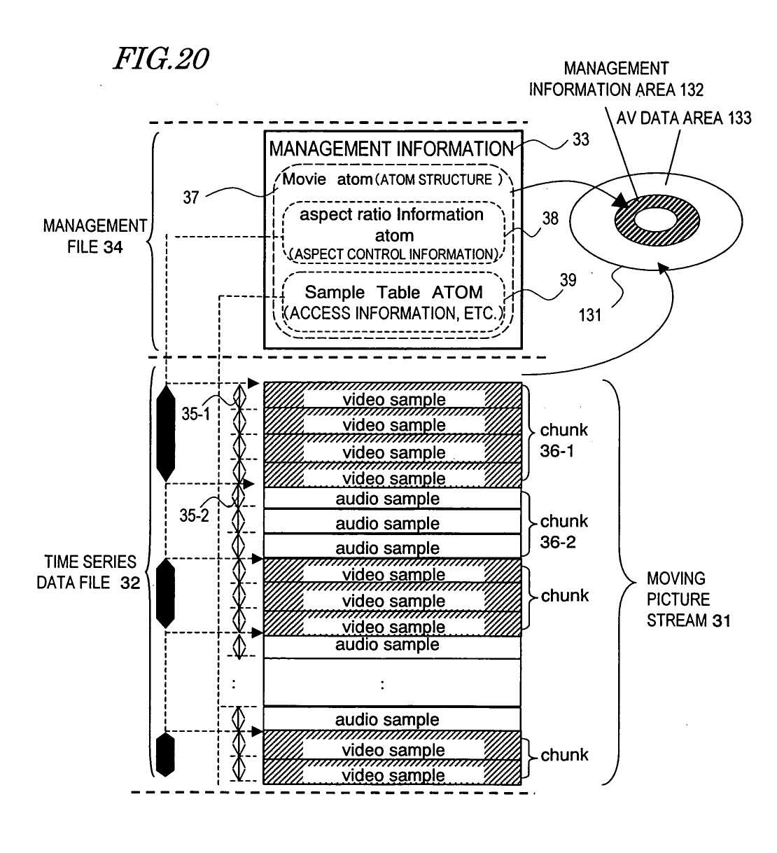

FIG. 20 shows the data structure of a moving picture file (e.g., an MP4 file or a QuickTime file) stored on the optical disc 131. The moving picture file includes a time series data file 32 with a moving picture stream 31 and a management file 34 with management information 33. The time series data file 32 is written on an AV data area 133 of the optical disc 131, while the management file 34 is written on the management information area 132 of the optical disc 131.

Movie Atom 37 that defines the management information 33 includes an atom 38 defining the aspect control information and Sample Table Atom 39 defining the access information and so on. In this example, the atom 38 defining the aspect control information is provided outside of Sample Table Atom 39. Alternatively, the atom 38 defining the aspect control information may be provided inside of Sample Table Atom 39. The access information in Sample Table Atom 39 is provided for each video sample and each audio sample in the moving picture stream 31. On the other hand, the aspect control information is defined for each video chunk, which is a set of a plurality of video samples. In FIG. 20, a video sample 35-1 and a video chunk 36-1, including the sample 35-1, and an audio sample 35-2 and an audio chunk 36-2, including the sample 35-2, are illustrated.

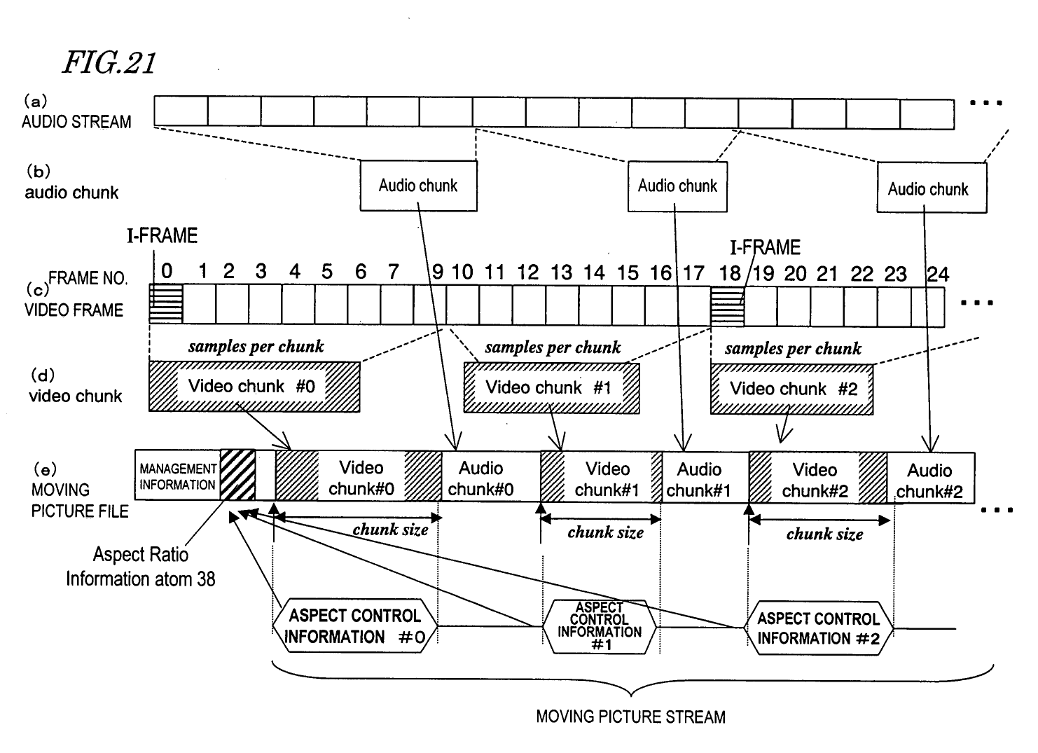

FIGS. 21(a) through 21(e) show a correlation between the data structures of an audio stream, audio chunks, a video stream and video chunks for generating a moving picture stream according to this preferred embodiment and that of a moving picture file generated. As shown in FIG. 21(e), different pieces of aspect control information are applied to respective video chunks. Every piece of aspect control information is described in Aspect Ratio Information Atom 38 within the management information.

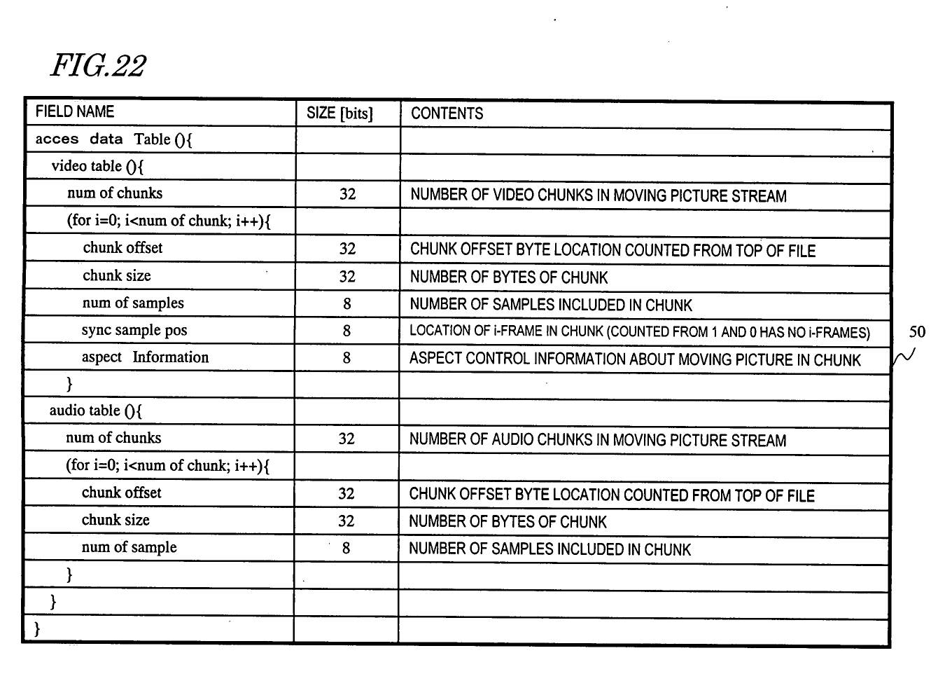

FIG. 22 shows data fields defined for the management information. In the video table field, which includes a group of management information for video data, the access information such as the offsets and sizes of respective samples or chunks is stored and a field (Aspect Information) 50 for defining aspect-related 8-bit information for those samples or chunks is included.

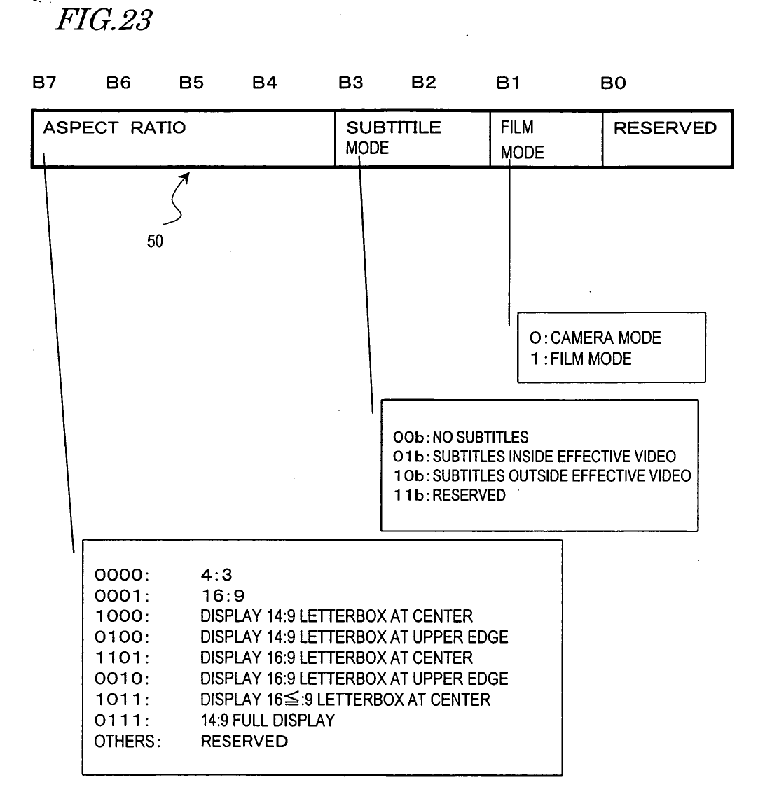

FIG. 23 shows the data structure of the field 50 for defining the aspect-related information. In the 8-bit field, the aspect control information 19 is defined by the most significant four bits B4 through B7 (ASPECT RATIO). The same aspect ratios as those shown in FIG. 14 may be defined by the aspect control information 19. A subtitle mode is defined by the next two bits B2 and B3 (SUBTITLE MODE), information indicating whether the video is a film mode or a camera mode is defined by the next one bit, and the least significant two bits are reserved.

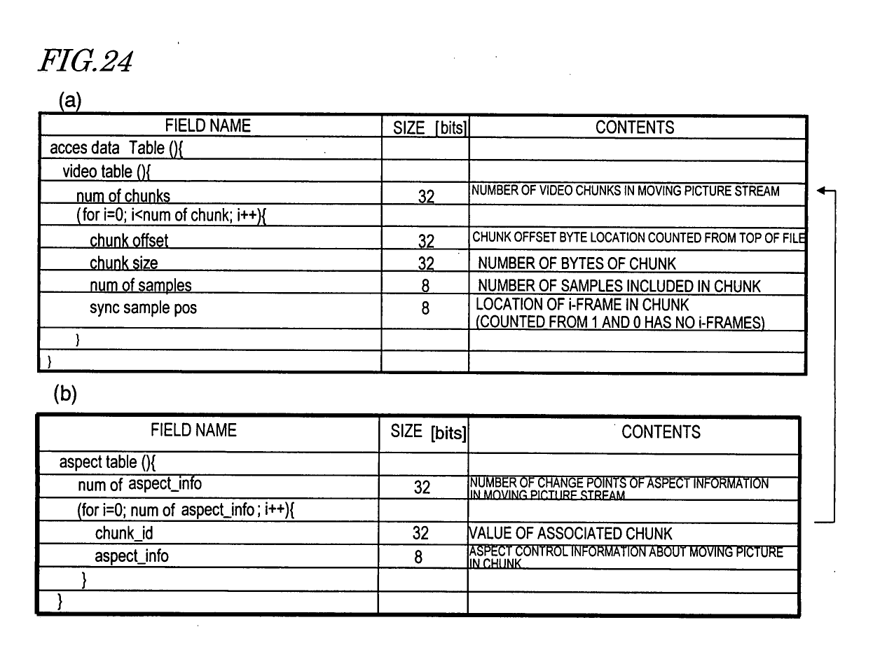

FIGS. 24(a) and 24(b) show the data structures of the management information for managing the aspect ratio change point. The management information defines the same number of pieces of aspect control information for a chunk as the number of times the aspect ratio has changed. More specifically, the number of times the aspect ratio has changed in a moving picture stream is stored in “num of aspect info”, an ID for identifying the chunk in which the change has occurred is stored in “chunk id”, and the aspect control information applied to the chunk is stored in “aspect info”.

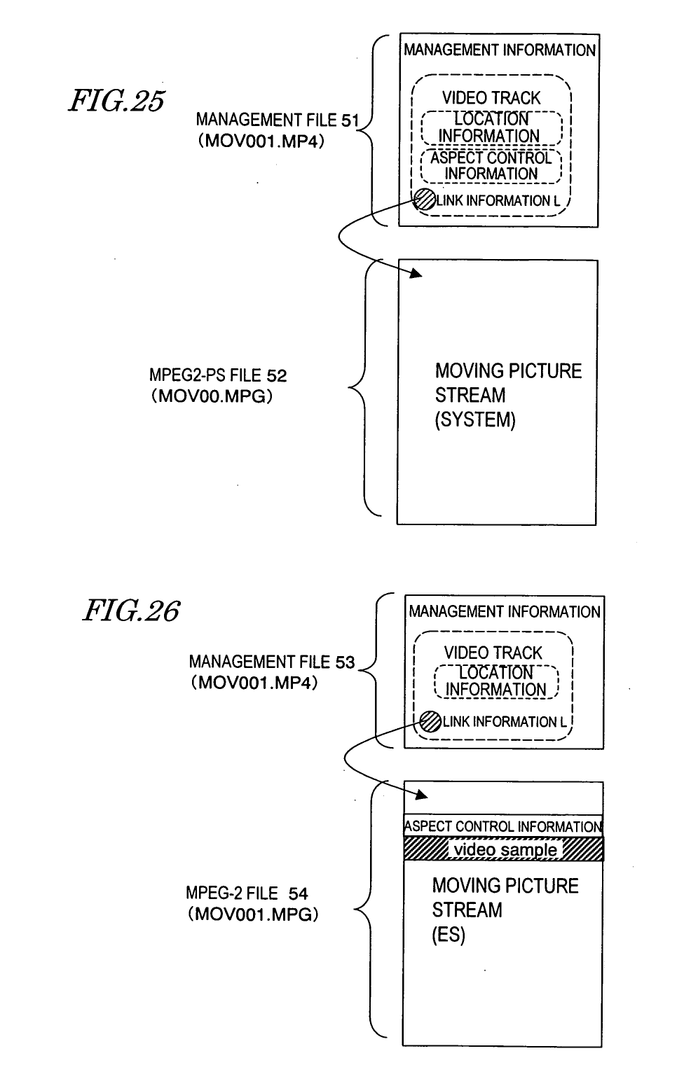

The first and second preferred embodiments of the data processor 10 of the present invention have been described on the supposition that an MP4 file or a QuickTime file is generated as a combination of a management file and a time series data file. Alternatively, only the management file may be generated as either an MP4 file or a QuickTime file and link information to the moving picture stream may be stored and managed in the management information of the management file. FIG. 25 shows a format in which link information L is provided in the management information such that an MPEG2-PS file, storing a moving picture stream, is identified by the link information L. The link information L may be the file name of its associated MPEG2-PS file, for example. In this example, the MPEG2-PS file is supposed to be a program stream (PS) compliant with the MPEG-2 standard. Optionally, a transport stream (TS) or an elementary stream (ES) may be stored instead. FIG. 26 shows a format in which the link information L provided within a management file 53 provides a link to an MPEG-2 file 54 storing an elementary stream (ES). The aspect control information is stored in the header portion of the MPEG-2 file 54 and is identified by the link information in the management file 53 so as to be read out.

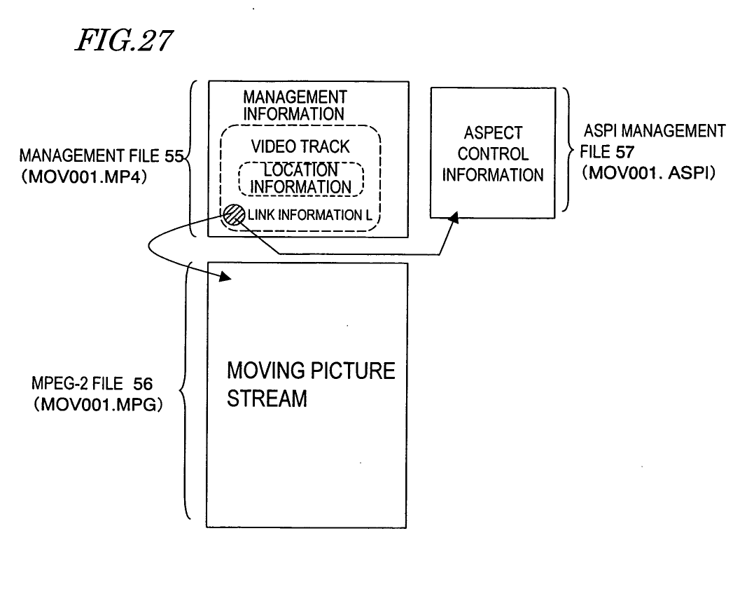

FIG. 27 shows a format in which the aspect control information is defined as a separate file named “ASPI management file” 57 and is associated with a management file 55 and an MPEG-2 file 56 by the file name, for example. According to this format, the aspect control information can be managed with compatibility with conventional ones maintained. It should be noted that the file name “ASPI management file” and the file extension “ASPI” shown in FIG. 27 are just examples and may be any other file name and any other extension. Also, any arbitrary file format may be adopted in storing the aspect control information.

As described above, aspect control information according to the present invention may be stored at any location, and encoded video data to be controlled by the aspect control information can be located, without being limited by the data structure of the management information or the file format. The data processor 10 of this preferred embodiment is supposed to handle either an MP4 file or a QuickTime file as a data file. In any case, however, the data processor 10 can perform the processing with the same configuration and can achieve the same effects. Also, extensions such as “MP4” have been used with reference to the drawings. However, the extensions are not limited to those adopted. For example, an extension such as “MOV” or any other extension may be used for a QuickTime file.

### Embodiment 3

A data processor according to a third preferred embodiment defines copy control information, indicating whether the given video may be recorded or not, as a piece of management information instead of the aspect control information. The copy control information may be defined in place of the “aspect control information” in the data structures shown in FIGS. 6 and 20, for example. By using the copy control information, the copyright of a content being written on a storage medium can be protected.

In the following description, the “copy control information” to replace the “aspect control information” will be pointed out by reference to the same drawings as those used in the foregoing description for convenience sake. However, even the aspect control information that is not particularly mentioned may also be replaced with the copy control information in the same way.

Hereinafter, a data processor according to the third preferred embodiment of the present invention will be described. The data processor of this preferred embodiment has the same configuration as, but performs different processing from, the data processor 10 of the first preferred embodiment (shown in FIG. 4). Thus, respective components of the data processor 10 of this preferred embodiment will be described in connection with the specific processing thereof.

Just like the aspect control information described above, the copy control information to be handled by the data processor 10 of this preferred embodiment is also included in the second control information. Accordingly, following the procedure of generating the management information shown in FIG. 8, the data processor 10 generates the copy control information as the second control information in Step S2, and then generates the management information in Step S3. Step S1 of generating the access information is the same here.

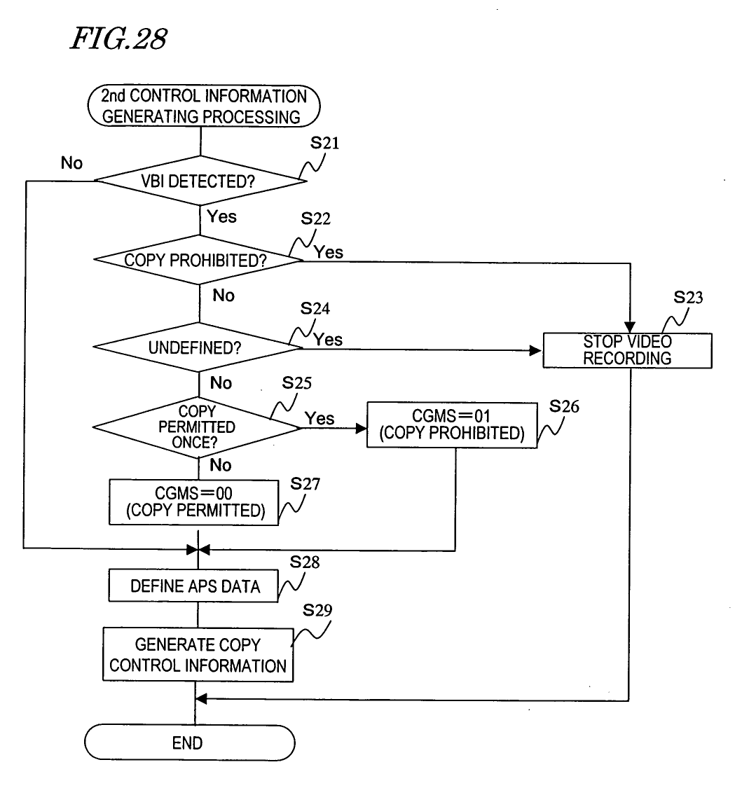

Hereinafter, the processing step S2 of generating the second control information shown in FIG. 8 will be described in detail with reference to FIG. 28. FIG. 28 shows a procedure to generate the copy control information. First, in Step S21, the VBI signal detecting section 104 determines whether or not the detecting section 104 has detected a VBI signal. If the answer is NO, then the process jumps to Step S28. On the other hand, if the answer is YES, then the second information generating section 105 extracts copy information from the VBI signal and the process advances to the next step S22.

The copy information will be described in detail. Specifically, the copy information includes copy generation managing system (CGMS) information and analog protection system (APS) information.

The CGMS information is 2-bit data for managing generation-by-generation copying and is defined as follows according to its data values:

00b: copy permitted (unlimited);

01b: undefined;

10b: copy permitted once; and

11b: copy prohibited

where “b” represents a binary value.

On the other hand, the APS information is 2-bit data showing a type of copy protection applied to the input video signal and is defined as follows according to its data values:

00b: no copy protection;

01b: Type 1;

10b: Type 2; and

11b: Type 3

“Type 1” instructs the recorder such as a VCR to perform an operation of stirring the AGC circuit thereof. “Type 2” instructs the recorder to perform the AGC stirring operation and an operation of inverting color stripe 2 lines. And “Type 3” instructs the recorder to perform the AGC stirring operation and an operation of inverting color stripe 4 lines. The APS information relates to a copy protection method for an analog video signal as developed by Microvision Inc. and is simply called “Microvision”.

In the next step S22, the second information generating section 105 determines whether the CGMS information included in the copy information extracted requires “copy prohibited” or not. This decision is made by seeing if the data value of the CGMS information is “11” or not. If the answer is YES, then copy is prohibited and the process advances to Step S23. Otherwise, copy is not prohibited and the process advances to Step S24. In Step S23, the data processor 10 stops the video recording operation, thereby ending the processing.

In Step S24, the second information generating section 105 determines whether the CGMS information is undefined or not. This decision is made by seeing if the data value of the CGMS information is “01” or not. If the answer is YES, then the process advances to Step S23, in which the video recording operation is stopped to end the processing. Otherwise, the process advances to Step S25.

In Step S25, the second information generating section 105 determines whether the CGMS information may be copied once or not. This decision is made by seeing if the data value of the CGMS information is “10” or not. If the answer is YES, then the process advances to Step S26. Otherwise, the process advances to Step S27. In Step S26, the second information generating section 105 sets the data value of the CGMS information equal to either “01” or “11”. As mentioned above, when the data value is “01”, the data processor 10 does not perform the video recording operation. In Step S27 on the other hand, the second information generating section 105 sets the data value of the CGMS information equal to “00”, indicating that copy is allowed, thereby recording the video and advancing the process to Step S28.

In Step S28, the second information generating section 105 defines the APS data in accordance with the APS information included in the copy information extracted. The APS data may be defined as 2-bit data corresponding to each data value of the APS information, for example, and is sometimes called “APS trigger bits (APSTB)”. By performing these processing steps, the second information generating section 105 generates copy control information based the CGMS information and APS data generated. The copy control information includes copy protection information, showing a method for protecting the encoded stream from being copied, and status information indicating whether the copy protection information is valid or not.

The management information generating section 106 describes the copy control information, which has been generated in this manner, in the management information 13. For example, the management information generating section 106 may describe the copy control information in the area for the “aspect control information” shown in FIG. 10, 16 or 17. If the copy control information is described in accordance with the data structure shown in FIG. 10 or 16, then the application range of the copy control information is defined either on a sample-by-sample basis or on a chunk-by-chunk basis. On the other hand, if the copy control information is described in accordance with the data structure shown in FIG. 17, then the application range of the copy control information is a plurality of chunks.

In FIGS. 15 and 21, if the “aspect control information” is replaced with the “copy control information”, then the concept of applying the copy control information to each chunk can be illustrated. FIG. 15 shows an example in which the time series data file 12 includes P2Samples. The management information generating section 106 describes the copy control information in the fields for Sample Description Entries 515a to 515c, etc. shown in FIG. 15. Sample Description Entries are defined in Sample Description Atom within Sample Table Atom. On the other hand, FIG. 21 shows an example in which the time series data file 12 includes video samples and audio samples. In FIG. 21, the copy control information is applied to the video samples.

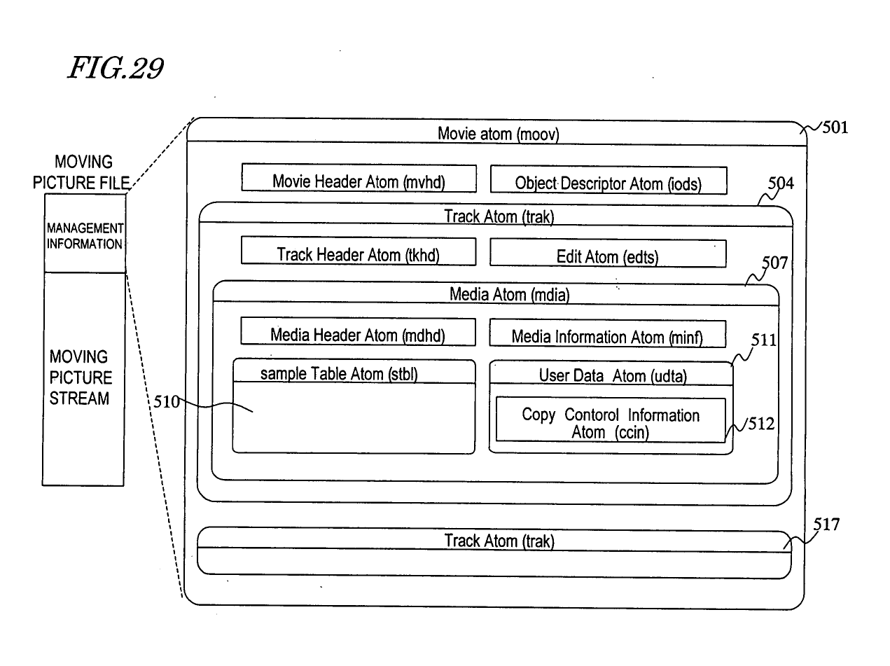

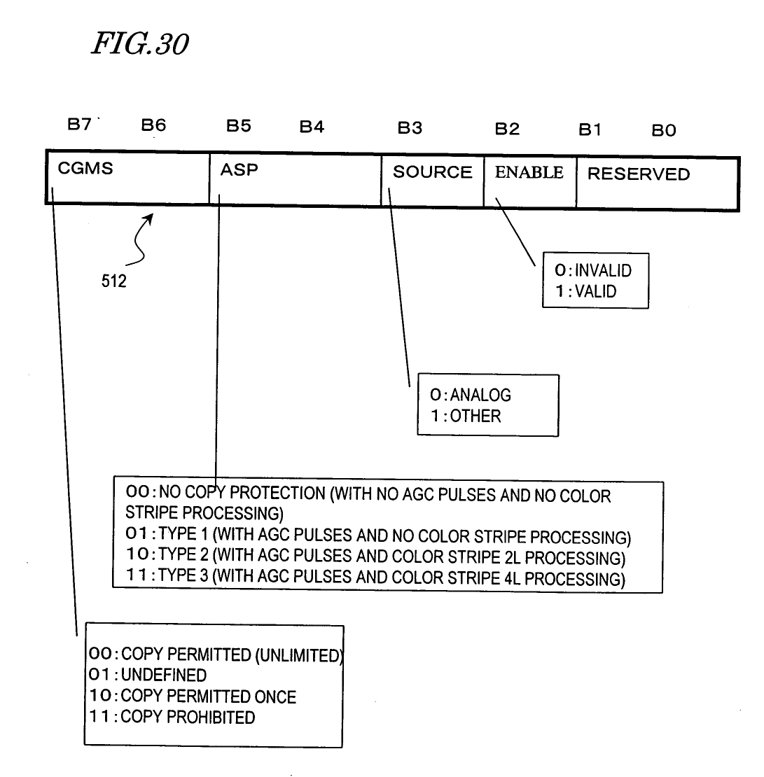

Alternatively, the management information generating section 106 may describe the copy control information in a different atom, not in Sample Table Atom. FIG. 29 shows a Copy Control Information Atom field 512 provided in User Data Atom 511. User Data Atom 511 is defined as a different atom from Sample Table Atom 510. But User Data Atom 511 and Sample Table Atom 510 are both included in Media Atom 507. FIG. 30 shows the data structure of the Copy Control Information Atom field 512. The most significant two bits B6 and B7 define the CGMS information and the next two bits B4 and B5 define the ASP information. The CGMS information and the ASP information are pieces of information showing a method for protecting the encoded stream from being copied and correspond to the copy protection information mentioned above. The contents defined by the CGMS information and the ASP information are as described above. The next one bit B3 defines source information indicating whether the video source is analog or not (e.g., digital). The next one bit B2 defines status information indicating whether the CGMS information and the ASP information represented by the most significant four bits are valid or invalid. The least significant two bits are reserved.

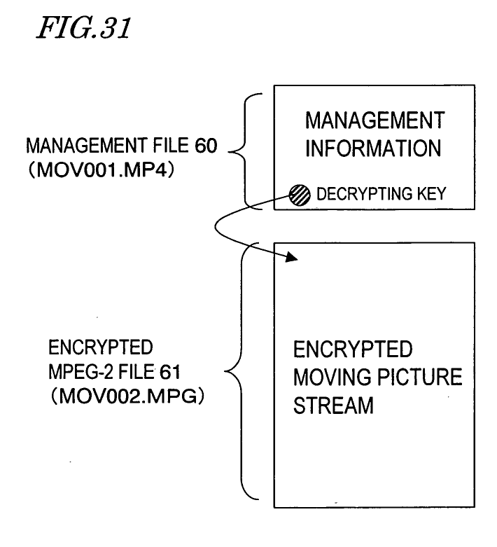

By defining the copy control information as described above, the management information can be defined so as to protect the copyright of a content. Optionally, to consolidate the copyright protection of a content, the data processor 10 may encrypt the time series data of a content, which can be copied only a limited number of times, and then store the encrypted data on the DVD-RAM 131, for example. Even if the management information includes the copy control information, the link information L may be provided for the management information so as to identify the file, in which the moving picture stream is stored, by the link information L as shown in FIGS. 25 through 27, for example. In such a format, the management information including the copy control information and the moving picture stream are provided as separate files. FIG. 31 shows a management file 60 in which a decrypting key K is stored within the management information and an MPEG-2 file 61 in which an encrypted moving picture stream (e.g., a system stream as defined by the MPEG-2 system standard) is stored. The moving picture stream can be decrypted with the decoding key K. By encrypting the moving picture stream and by storing the key K, which needs to be used to decrypt that moving picture stream, in a separate file (i.e., the management file 60), the copyright protection can be consolidated.

The management information of this preferred embodiment has been described as including the copy control information instead of the aspect control information. However, since the aspect control information and the copy control information are different pieces of information, not only one of these two types of information but also the other type of information may be provided as well. For example, both of these two types of information may be provided either in Sample Description Atom 311 within Sample Table Atom 18 (see FIG. 11) or within User Data Atom 511 (see FIG. 29). Alternatively, these two types of information may be provided in mutually different atoms within Sample Table Atom 18. It is also possible to provide one of the two types within Sample Table Atom 18 and the other within User Data Atom 511, respectively. It should be noted that if the contents of either the copy control information or the aspect control information have changed, then a new sample and a new chunk are formed.

In the first through third preferred embodiments of the data processor of the present invention described above, the data written by the data processor 10 on the storage medium has a data structure including moving picture data and management information. Such data can be read out from the storage medium either by the data processor 10 or any other device having a playback function. In any case, the device can acquire the management information appropriately depending on the data structure of the stored data and can reproduce the video from the moving picture data in accordance with the management information. The data structure of the management information is clearly different from the conventional one in terms of the storage locations and modes of the aspect control information and/or the copy control information.

The data processor 10 (see FIG. 1) according to each of the preferred embodiments described above is supposed to have both the recording function and the playback function alike. However, the data processor 10 may also be a device performing just one of these two functions. For example, if the data processor 10 is implemented as a player with only the playback function, then the player may analyze the data structure described above and read and process the aspect control information and/or copy control information. The recording and playback functions of the data processor are executed by a computer program that can perform those functions. By either storing the computer program on a storage medium such as a CD-ROM and putting that storage medium on the market or downloading the program via telecommunications lines such as the Internet, a computer system, for example, may operate as the recorder and/or the player.

In the foregoing description, an MPEG-2 video stream is adopted. However, the present invention is also applicable for use with any other video stream such as an MPEG-4 video stream.

### INDUSTRIAL APPLICABILITY

According to the present invention, when management information and a moving picture stream, of which the processing is managed in accordance with the management information, are written as at least one file on a storage medium, aspect control information and/or copy control information are/is included in the management information. Thus, the moving picture stream can be played back, duplicated and transferred with the intention of the broadcaster or copyright owner of a content respected.

Among other things, if the file to store the management information is an MP4 file compliant with the MPEG-4 system standard (ISO/IEC 14496-1), then a higher degree of compatibility with PCs is guaranteed.

1. A data storage apparatus comprising:
a video signal receiving section for receiving a video signal representing video and aspect information to control aspect ratio of the video;
an audio signal receiving section for receiving an audio signal representing audio;
a detecting section for detecting the aspect information from the video signal;
a stream generating section for generating encoded data by encoding the video and audio signals by a predetermined encoding technique and also generating an encoded stream as a set of the encoded data;
management information generating section for generating management information which is used to manage process of the encoded stream, the management information including the aspect information for each set of the encoded data; and
a writing section for storing the management information and the encoded stream as at least one file on a storage medium.

2. The data storage apparatus of claim 1, wherein when the set of the encoded data is treated as one sample, the management information generating section generates common aspect information for the video in each sample.

3. The data storage apparatus of claim 2, wherein when a plurality of samples are treated as one chunk, the management information generating section generates common aspect information for the video in each chunk.

4. The data storage apparatus of claim 3, wherein the management information generating section generates and stores the aspect information in a field of the management information for describing an attribute of each said sample.

5. The data storage apparatus of claim 4, wherein if the at least one file is compliant with the QuickTime standard, then the field is a Sample Table Atom (stbl) field, and
wherein if the at least one file is compliant with the MP4 standard, then the field is a Sample Table Box (stbl) field.

6. The data storage apparatus of claim 3, wherein the management information generating section generates and stores the aspect information in a field of the management information for describing user data with respect to the encoded stream.

7. The data storage apparatus of claim 6, wherein if the at least one file is compliant with the QuickTime standard, then the field is a User Data Atom field, and
wherein if the at least one file is compliant with the MP4 standard, then the field is a User Data Box field.

8. The data storage apparatus of claim 4, wherein the management information generating section further stores access information, which is needed in accessing each said sample to which the aspect information is applied, in the field, the access information including at least one of the number of samples included in the chunk and the playback duration, data storage location and data size of each said sample.

9. The data storage apparatus of claim 1, wherein the video signal includes copy information indicating whether the video signal may or may not be copied, and
wherein the detecting section detects the copy information from the video signal, and
wherein the management information generating section further generates copy control information as another piece of the management information, the copy control information including copy protection information, showing a method of protecting the encoded stream from being copied in accordance with the copy information, and status information indicating whether the copy protection information is valid or not.

10. The data storage apparatus of claim 9, wherein if the copy information indicates that copy of the video signal is permitted at least once, then the management information generating section generates the copy control information.

11. The data storage apparatus of claim 10, wherein the management information generating section generates common copy control information for the video in each said sample.

12. The data storage apparatus of claim 11, wherein the management information generating section generates common copy control information for the video in each said chunk.

13. The data storage apparatus of claim 12, wherein if the at least one file is compliant with the QuickTime standard, then the management information generating section describes the copy control information in one of a Sample Table Atom (stbl) field and a User Data Atom (udta) field, and
wherein if the at least one file is compliant with the MP4 standard, then the management information generating section describes the copy control information in one of a Sample Table Box (stbl) field and a User Data Box field.

14. A data storage method comprising the steps of:
receiving a video signal representing video and aspect information to control aspect ratio of the video;
receiving an audio signal representing audio;
detecting the aspect information from the video signal;
generating encoded data by encoding the video and audio signals by a predetermined encoding technique and also generating an encoded stream as a set of the encoded data;
generating management information which is used to manage process of the encoded stream, the management information including the aspect information for each set of the encoded data; and
storing the management information and the encoded stream as at least one file on a storage medium.

15. The data storage method of claim 14, wherein when the set of the encoded data is treated as one sample, the step of generating the management information includes generating common aspect information for the video in each sample.

16. The data storage method of claim 15, wherein when a plurality of samples are treated as one chunk, the step of generating the management information includes generating common aspect information for the video in each chunk.

17. The data storage method of claim 16, wherein the step of generating the management information includes generating and storing the aspect information in a field of the management information for describing an attribute of each said sample.

18. The data storage method of claim 17, wherein if the at least one file is compliant with the QuickTime standard, then the field is a Sample Table Atom (stbl) field, and
wherein if the at least one file is compliant with the MP4 standard, then the field is a Sample Table Box (stbl) field.

19. The data storage method of claim 16, wherein the step of generating the management information includes generating and storing the aspect information in a field of the management information for describing user data with respect to the encoded stream.

20. The data storage method of claim 19, wherein if the at least one file is compliant with the QuickTime standard, then the field is a User Data Atom field, and
wherein if the at least one file is compliant with the MP4 standard, then the field is a User Data Box field.

21. The data storage method of claim 17, wherein the step of generating the management information further includes storing access information, which is needed in accessing each said sample to which the aspect information is applied, in the field, the access information including at least one of the number of samples included in the chunk and the playback duration, data storage location and data size of each said sample.

22. The data storage method of claim 14, wherein the video signal includes copy information indicating whether the video signal may or may not be copied, and
wherein the step of detecting includes detecting the copy information from the video signal, and
wherein the step of generating the management information further includes generating copy control information as another piece of the management information, the copy control information including copy protection information, showing a method of protecting the encoded stream from being copied in accordance with the copy information, and status information indicating whether the copy protection information is valid or not.

23. The data storage method of claim 22, wherein if the copy information indicates that copy of the video signal is permitted at least once, then the step of generating the management information includes generating the copy control information.

24. The data storage method of claim 23, wherein the step of generating the management information includes generating common copy control information for the video in each said sample.

25. The data storage method of claim 24, wherein the step of generating the management information includes generating common copy control information for the video in each said chunk.

26. The data storage method of claim 25, wherein if the at least one file is compliant with the QuickTime standard, then the step of generating the management information includes describing the copy control information in one of a Sample Table Atom (stbl) field and a User Data Atom (udta) field, and
wherein if the at least one file is compliant with the MP4 standard, then the step of generating the management information includes describing the copy control information in one of a Sample Table Box (stbl) field and a User Data Box field.

27. A data playback apparatus comprising:
a reading section for reading an encoded stream as a set of encoded data and management information which is used to manage process of the encoded stream from a storage medium, the encoded data including a video signal representing video and an audio signal representing audio that have been encoded by a predetermined encoding technique;
a decoding section for decoding the encoded stream into the video signal and the audio signal;
an extracting section for extracting aspect information, which is defined for each said set of the encoded data to control the aspect ratio of the video, from the management information; and
a superposing section for outputting the aspect information after having superposed the aspect information on the video signal.

28. A data playback method comprising steps of:
reading an encoded stream as a set of encoded data and management information which is used to manage process of the encoded stream from a storage medium, the encoded data including a video signal representing video and an audio signal representing audio that have been encoded by a predetermined encoding technique;
decoding the encoded stream into the video signal and the audio signal;
extracting aspect information, which is defined for each said set of the encoded data to control the aspect ratio of the video, from the management information; and
outputting the aspect information that has been superposed on the video signal.

29. A data storage apparatus comprising:
a video signal receiving section for receiving a video signal representing video and copy information indicating whether the video may or may not be recorded;
an audio signal receiving section for receiving an audio signal representing audio;
a detecting section for detecting the copy information from the video signal;
a stream generating section for generating encoded data by encoding the video and audio signals by a predetermined encoding technique and also generating an encoded stream as a set of the encoded data;
a management information generating section for generating management information which is used to manage process of the encoded stream, the management information including copy control information that includes copy protection information, showing a method of protecting the encoded stream from being copied, and status information indicating whether the copy protection information is valid or not; and
a writing section for storing the management information and the encoded stream as at least one file on a storage medium if the copy information indicates that the video may be copied.
